(19) United States
(12) Patent Application Publication
(10) Pub. No.: US 2013/0087033 A1
(43) Pub. Date: Apr. 11, 2013

(54) Food Slicer with Safety and Adjustment Features

(71) Applicants: Joel Tetreault, Roswell, GA (US); Dean Olaya, Atlanta, GA (US); Jamison Float, Galloway, OH (US); Jay F. Perkins, Pickerington, OH (US); Ryan Berger, Columbus, OH (US)

(72) Inventors: Joel Tetreault, Roswell, GA (US); Dean Olaya, Atlanta, GA (US); Jamison Float, Galloway, OH (US); Jay F. Perkins, Pickerington, OH (US); Ryan Berger, Columbus, OH (US)

(73) Assignee: Calphalon Corporation, Atlanta, GA (US)

(21) Appl. No.: 13/270,094

(22) Filed: Oct. 10, 2011

(51) Int. Cl. B26D 7/22; B26D 3/28

(52) U.S. Cl. 83/440; 83/856

(57) ABSTRACT

A food slicer has a deck defining a food prep surface and a blade oriented laterally across the deck. The blade has a cutting edge exposed on the food prep surface. The blade can divide the deck into a pre-slice deck and a post-slice deck. An elevation of the pre-slice deck can be user adjustable relative to the position of the cutting edge to selectively adjust a slice thickness produced by the food slicer. The food slicer can also have a safety mechanism with a blade guard positioned adjacent the cutting edge. The blade guard is movable between a blocking position blocking the cutting edge and a slicing position exposing the cutting edge.

### BACKGROUND

1. Field of the Disclosure

The present disclosure is generally directed to food preparation devices, and more particularly to a mandolin-type food slicer with user selectable safety and adjustment features.

2. Description of Related Art

Kitchen gadgets for slicing food are known in the art. One type of food slicer can be found in both commercial kitchens and consumer kitchens in various forms. This type of slicer is known generally as a mandolin slicer. The typical mandolin slicer has a slicing deck with a blade spanning the width of the deck. The blade is arranged parallel to the deck so that, when a food item is slid along the deck, it is driven over and into the cutting edge of the blade. This slices off a relatively thin portion of the food item being sliced. The sliced portions of the food item fall below the deck and the remainder of the food item remains on top of the deck until passed over the blade again.

Mandolin slicers are known to be extremely efficient at slicing food. However, mandolin slicers are also known to be relatively dangerous. This is because the user must push food in the direction of and directly into a razor-sharp cutting edge of the blade. This is essentially the reverse operation required when using a traditional knife to slice food. A knife is typically held in the users hand and cuts into the food item. With a mandolin slicer, the food is held in the user's hand and directed toward the cutting edge of the blade. The hand of a user may rather easily and accidentally slip from the food item to be sliced. This can result in their hand accidentally or unintentionally coming into contact with the razor-sharp cutting edge. Users of advanced or a young age, or of limited strength, dexterity, and/or experience may be particularly vulnerable to this type of accidental injury.

To help alleviate this problem, mandolin slicers are often provided with a secondary product often called a pusher. The user places a food item on the slicing deck and uses the pusher instead of their bare hand to push the food item toward and into the blade. The user's hand can just as easily slip from the pusher as it can from the food item. Thus, use of a pusher is not much of a safety improvement for mandolin slicers, except that the pusher may help prevent direct contact with the cutting edge under normal and correct use of the slicer and pusher.

One manufacturer, Kitchen Aid, has produced a mandolin slicer with a modified pusher. The pusher has a gripping portion and extensions or plates on the leading and trailing ends of the gripping portion. The plates are intended to ride over the blade well before the user's hand, which holds the gripping portion, reaches the blade and also to cover the blade until well after the gripping portion and user's hand has passed the blade. The problem with this solution is that the user must apply a relatively large amount of force on the pusher to move the food item along the deck and through the blade. This is because the plates or extensions on the pusher, which lay between side walls adjacent the slicing deck, make it difficult to slide the pusher on the slicing deck. The lengthy edges of the plates create interference with the side walls of the deck while sliding. The extended plates also create additional friction between the sliding deck, food item, side walls, and pusher surfaces. Because the user must push relatively hard on the pusher in order to slice the food item, this can result in a rather dangerous situation. By requiring more force on the pusher, the user may be more likely to have their hand slip from the gripping portion of the pusher and come in contact with the cutting edge of the blade. Because the user is pushing hard on the pusher, their hand might be moving at greater speed and impact the blade under more force than when using a normal mandolin slicer.

The typical pusher has an interior cavity to hold a food item to be sliced. The cavity is not configured to hold elongate or large food items. The cavity is also not small enough to hold smaller food items. Thus, a user may directly hold and slice a small food item without use of the pusher. Also, once a food item becomes shorter or smaller from repeated slicing, the pusher must be abandoned. The remaining food item either not used or is again held directly by the user in order to apply sufficient pressure on the food item to continue slicing.

Mandolin-type food slicers are typically offered with a number of different blades to produce different food slice characteristics. These additional blades are typically stored in a separate tray or container and stored separately from the slicer. When a user wishes to change from a straight cut blade to a Julienne cut blade or a waffle cut blade, the user must first locate the stored container, remove the desired stored blade, remove the existing blade from the slicer, install the new blade, place the old blade in the container, and then return the container to storage. This can be cumbersome for the user, can takes up valuable storage space, and can result in lost or misplaced replacement blades.

The typical pusher is not suited to accommodate different grips for a user. The typical pusher is also not suited to accommodate certain oddly shaped or larger sized food items to be sliced. Also, the typical pusher does not adjust to the gradual reduction in size of a food item being sliced.

### SUMMARY

A food slicer in one example according to the teachings of the present invention has a deck defining a food prep surface and a blade oriented laterally across the deck. The blade has a cutting edge exposed on the food prep surface. A safety mechanism has a blade guard positioned adjacent the cutting edge and is movable between a blocking position blocking the cutting edge and a slicing position exposing the cutting edge. The safety mechanism can be user configured to allow selective movement of the blade guard between the blocking position and the slicing position.

In one example, the safety mechanism can have an actuator that is user actuable to move the blade guard from the blocking position to the slicing position. Releasing the actuator can allow the blade guard to return to the blocking position.

In one example, the safety mechanism can have an actuator adjacent the deck that, when actuated, can move the blade guard to the slicing position and, when released, permits the blade guard to return to the blocking position. In one example, the actuator can be a handle that is depressed relative to the frame when actuated.

In one example, the safety mechanism can be user configured to lock the blade guard in the blocking position and can be user configured to release the blade guard for selective movement from the blocking position to the slicing position.

In one example, the blade can divide the deck into a pre-slice deck and a post-slice deck. The elevation of the pre-slice deck can be adjustable relative to the position of the cutting edge to adjust a slice thickness produced by the food slicer.

In one example, the blade can be generally V-shaped and the blade guard can have a guard wall that is likewise V-shaped.

In one example, the blade guard can be lowered below a level of the cutting edge in the slicing position.

In one example, the safety mechanism can include a selection device that is movable among a plurality of different user selectable positions.

In one example, the safety mechanism can include a selection device that can be movable to a locked position whereby the safety mechanism is maintained in a locked mode preventing the blade guard from moving to the slicing position.

In one example, the safety mechanism can include a selection device that can be movable to a guard OFF position whereby the safety mechanism is maintained in a guard OFF mode preventing the blade guard from returning to the blocking position.

In one example, the safety mechanism can include a selection device that can be moved to a guard OFF position only if the blade guard is in the slicing position, the blade retained in the slicing position in the guard OFF position.

In one example, the safety mechanism can include a selection device that can be a rotatable selection knob and the safety mechanism can have a cam disc coupled to the selection knob for rotation therewith.

In one example, the safety mechanism can include an actuator and a drive rod that can connect the blade guard to the actuator whereby selective actuation of the actuator moves the blade guard.

In one example, the safety mechanism can include a cam disc that cooperates with a drive rod to lock the blade guard in the blocking position and to release the blade guard, depending on the position of a selection knob.

In one example, when the safety mechanism is in a locked mode, an actuator can be configured so as not to be actuable to move the blade guard or the blade guard can be prevented from moving from the blocking position.

In one example, when the safety mechanism is in an unlocked mode, an actuator can be actuable to move the blade guard to the slicing position and, when released, to allow the blade guard to return to the blocking position.

In one example, the safety mechanism can be selectively user arranged to a locked mode preventing the blade guard from moving from the blocking position.

In one example, the safety mechanism can be selectively user arranged to a guard ON mode releasing the blade guard for selective movement between the blocking position and the slicing position.

In one example, the safety mechanism can be selectively user arranged to a guard OFF mode locking the blade guard in the slicing position.

In one example, the deck can be provided on an upper tray. The safety mechanism can be configured to be selectively arranged to a tray release mode, whereby the upper tray can be released from and movable relative to a frame of the food slicer to a position providing access beneath the deck within the frame.

A food slicer in one example according to the teachings of the present invention has a deck defining a food prep surface and a blade oriented laterally across the deck. The blade has a cutting edge exposed on the food prep surface and dividing the deck into a pre-slice deck and a post-slice deck. An elevation of the pre-slice deck can be user adjustable relative to the position of the cutting edge to selectively adjust a slice thickness produced by the food slicer.

In one example, the food slicer can have a knob rotatable to a plurality of user selectable orientations. Each of the orientations can be associated with a different elevation of the pre-slice deck.

In one example, the food slicer can have a knob rotatable to a release orientation allowing removal of the pre-slice deck.

In one example, the food slicer can have a safety mechanism with a blade guard positioned adjacent the cutting edge and movable between a blocking position blocking the cutting edge and a slicing position exposing the cutting edge.

### BRIEF DESCRIPTION OF THE DRAWINGS

Objects, features, and advantages of the present invention will become apparent upon reading the following description in conjunction with the drawing figures, in which:

FIG. 1 shows a front perspective view of one example of a kitchen gadget including a pusher and a mandolin-type food slicer constructed in accordance with the teachings of present invention.

FIG. 2 shows a side perspective view of the mandolin slicer of the kitchen gadget shown in FIG. 1.

FIG. 3 shows a rear perspective view of the mandolin slicer shown in FIG. 2.

FIG. 4 shows a perspective exploded view of parts of a safety mechanism of the mandolin slicer shown in FIG. 2.

FIG. 5 shows a top assembled view of the parts of the safety mechanism shown in FIG. 4.

FIG. 6 shows a side view of the assembled safety mechanism parts shown in FIG. 5 in a blocking mode and shows a selection knob in a locked position.

FIG. 7 shows a cross-section taken along line 7-7 of the safety mechanism shown in FIG. 5, but with no blade guard shown therein.

FIG. 8 shows a cross-section taken along line 8-8 of the safety mechanism shown in FIG. 5 but with no blade guard shown therein.

FIG. 9 shows a cross-section taken along line 9-9 of the safety mechanism shown in FIG. 5 but with no blade guard shown therein.

FIG. 10 shows a bottom perspective view of part of the mandolin slicer shown in FIG. 2 including the safety mechanism in the blocking mode of FIG. 6.

FIG. 11A shows a side view of parts of the mandolin slicer shown in FIG. 2, including the upper tray, and the safety mechanism and selection knob as shown in FIGS. 5 and 6.

FIG. 11B shows the mandolin slicer parts shown in FIG. 11A with the selection knob in a handle release position.

FIG. 11C shows a cam disc of the selection knob in the handle release position shown in FIG. 11B.

FIG. 11D shows a close up cross-section similar to that in FIG. 9, but of the mandolin slicer parts shown in FIG. 11B and with the blade guard in a blocking position of the blocking mode.

FIG. 12A shows the mandolin slicer parts shown in FIG. 12B, but with a handle of the safety mechanism pressed down or actuated.

FIG. 12B shows a side view of the safety mechanism similar to that in FIG. 6, but with the safety mechanism in a slicing mode.

FIG. 12C shows the bottom perspective view of the mandolin slicer shown in FIG. 10, but with the safety mechanism in the slicing mode of FIG. 12B.

FIG. 12D shows the close up cross-section shown in FIG. 11D, but with the blade guard shown therein in a retracted position of the slicing mode.

FIG. 13A shows the cam disc of the selection knob in the unlocked position and with the handle of the safety mechanism pressed or actuated as shown in FIG. 12A.

FIG. 13B shows the mandolin slicer parts shown in FIG. 12A, but with the selection knob in an off position.

FIG. 13C shows the cam disc of the selection knob in the off position shown in FIG. 13B.

FIG. 14A shows the mandolin slicer parts shown in FIG. 13B, but with the selection knob in a tray release position.

FIG. 14B shows the cam disc of the selection knob in the tray release position shown in FIG. 14A.

FIG. 15 shows the mandolin slicer parts shown in FIG. 14A, but with the upper tray pivoted upward to a blade change condition.

FIG. 16A shows an opposite side view of the mandolin slicer of FIGS. 1-3, and with an adjustment knob in a deck raised position.

FIG. 16B shows a cross section similar to that of FIG, 9, but of the mandolin slicer shown in FIG. 16 with the adjustable deck in a minimum slice position.

FIG. 17A shows the mandolin slicer shown in FIG. 16A, but with the adjustment knob in a deck lowered position.

FIG. 17B shows the mandolin slicer shown in FIG. 16B, but with the adjustable deck in a maximum slice position.

FIG. 18A shows the mandolin slicer shown in FIG. 17A, but with the adjustment knob in a deck release position.

FIG. 18B shows the mandolin slicer shown in FIG. 17B, but with the adjustable deck removed.

FIG. 19 shows an underside perspective view of the pusher for the kitchen gadget shown in FIG. 1.

FIG. 20 shows a cross-section taken along line 20-20 of the pusher shown in FIG. 19, but with a top cap separated from a body of the pusher.

FIG. 21 shows the pusher of FIG. 20 in a collapsed or compact condition and with the top cap attached.

FIG. 22A shows a partial exploded view of the mandolin slicer for the kitchen gadget shown in FIG. 1 and with the upper tray removed and the various optional blades separated from the frame.

FIG. 22B shows the mandolin slicer of FIG. 22A with the various optional blades partially installed on the frame.

FIG. 22C shows the mandolin slicer of FIG. 22B with the various optional blades installed on the frame.

FIG. 23 shows a perspective view of the mandolin slicer shown in FIG. 22A with the various optional blades removed.

### DETAILED DESCRIPTION OF THE DISCLOSURE

The mandolin slicer disclosed and described herein solves or improves upon one or more of the above-noted and/or other problems and disadvantages with prior known food slicers of this type. In one example, a mandolin slicer disclosed and described herein has a safety mechanism that can be actuated to permit or prevent movement of a blade guard. In one example, a part of the disclosed blade guard, when in a blocking position, lies closely adjacent the cutting edge of the blade in a blocking mode of the safety mechanism. In one example, the disclosed blade guard can be moved to a retracted position exposing the cutting edge in a slicing mode of the safety mechanism. In one example, the disclosed safety mechanism can be actuated to selectively prevent or permit movement of the blade guard from the blocking position to the retracted position. In one example, the disclosed safety mechanism can be actuated to move the blade guard from the blocking position to the retracted position. In one example, the disclosed safety mechanism can be actuated to an off mode so as to hold the blade guard in the retracted position. In one example, the disclosed safety mechanism can be actuated to a tray release mode so as to permit access to the blade to swap out one blade for another. These and other objects, features, and advantages of the present invention will become apparent to those having ordinary skill in the art upon reading this disclosure.

Much of the safety mechanism disclosed and described herein is with reference to left side components on the disclosed gadget. As mentioned several times below, the right side components essentially the same as or minor images of the left side components, unless specifically mentioned otherwise. Also, use of the directional references “front” or “forward” refers to the front end of the gadget or in a direction toward or nearer the front or forward end, as defined below. Likewise, use of the directional references “back” or “rearward” or “rear” refers to the rear end of the gadget or in a direction toward or nearer the rear end or back end, as defined below. Similarly, use of the directional references “up” or “upward” or “raise” and the like refers to the top or food prep side of the gadget or in a direction toward or nearer the top or food prep side, as defined below. Again likewise, use of the directional references “bottom” or “lower” or “under” or the like refers to the underside or bottom of the gadget opposite the food prep side or in a direction toward or nearer the bottom or underside, as defined below.

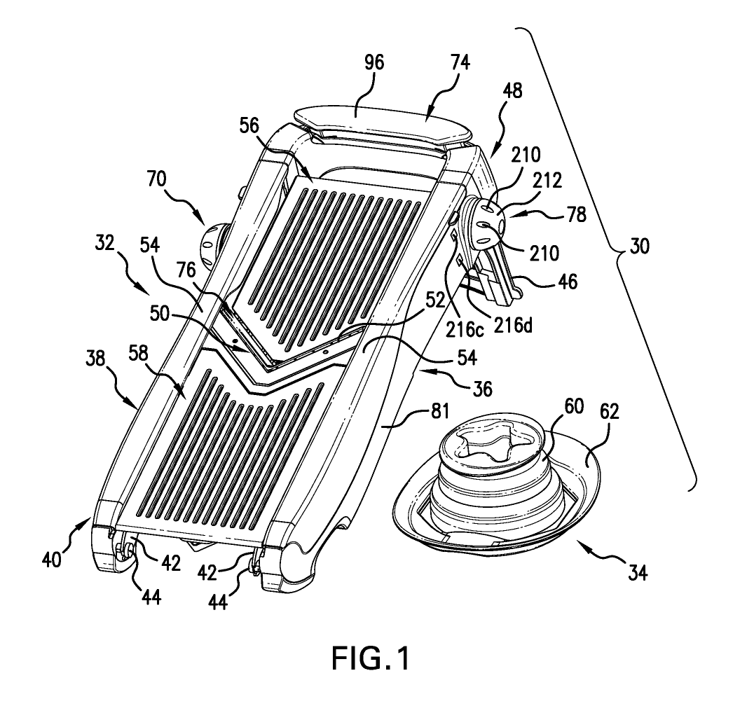

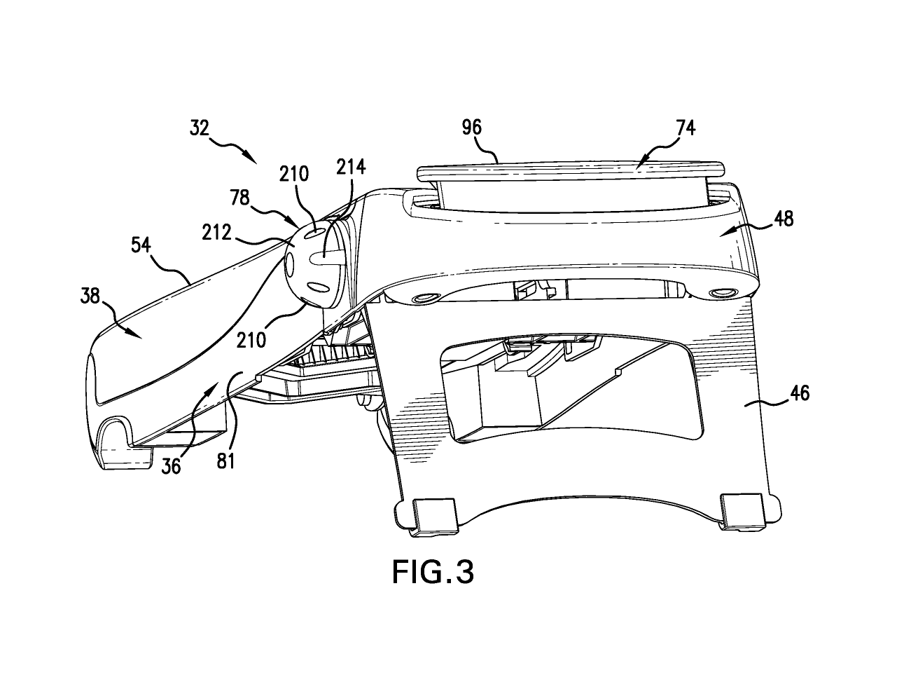

Turning now to the drawings, FIGS. 1-3 show one example of a food slicing gadget 30 constructed in accordance with the teachings of the present invention. In this example, the gadget 30 has a mandolin slicer 32 and a pusher 34. In general, the mandolin slicer 32 has a support frame 36 and an upper tray 38 supported on the frame. A forward end 40 of the upper 38 has extensions 42 at the front corners that are pivotally connected via pins 44 to the frame 36 for reasons described below. The mandolin slicer 32 also has a kickstand 46 pivotally connected to the rear end 48 of the frame 36. The kickstand 46 (as briefly mentioned further below) can be pivoted up and stowed under the frame 36 when the gadget 30 is stored. The kickstand 46 can be extended or deployed downward from the frame 36 as shown to elevate the rear end 48 of the mandolin slicer 32 during use.

The mandolin slicer 32 also generally has a blade 50 with a cutting edge 52 facing the rear end 48. The blade 50 is mounted to the upper tray 38 and extends laterally across between side rails 54 of the tray. In this example, the blade 50 is V-shaped and concave in the cutting edge direction. However, the blade shape, orientation, and position can vary from the example shown and described herein. For example, the blade can have a linear cutting edge extending laterally across, but perpendicular to the side rails 54. Other blade configurations and arrangements are certainly possible.

The upper tray 38 generally has two parts separated by the blade 50. The two parts form a deck defining a food prep surface on a top side of the upper tray 38. The cutting edge 52 can be exposed on the food prep surface for use in slicing food items. The deck has a take-off or pre-slice deck 56 is positioned on the cutting edge side of the blade 50. The deck also has a landing or post-slice deck 58 is positioned on the opposite side of the blade 50 near the forward end 40. Food to be sliced is typically placed on the takeoff or pre-slice deck 56 and pushed toward the cutting edge 52. The bulk of the food item will land on the post-slice deck 58. A sliced off portion of the food item (not shown) will fall below the blade 50 beneath the landing or post-slice deck 38, as is known in the art.

The pusher 34 of the kitchen gadget 30 in this example has a hand grip portion 60 configured in the form of a multi-diameter, stepped cylinder. The pusher 34 also has an outward extending rim or flange 62. The rim 62 extends circumferentially around the grip portion 60 and has a larger diameter than the grip portion 60, which helps to protect a user's fingers while using the mandolin slicer 32. The use of a pusher, such as the pusher 34, is well known in the art. The pusher 34 is placed on and/or against the food item to be sliced and is pushed to drive the food item along the pre-slice deck 38 and into the blade 50.

As will be evident to those having ordinary skill in the art, the above aspects of the mandolin slicer 32 and pusher 34 of the kitchen gadget 30 can vary in configuration and construction and yet fall within the spirit and scope of the present invention. These various aspects and components can be made from numerous different materials, such as metal, aluminum, molded plastic, or the like, and take on many different shapes, sizes, contours, and features without affecting the function of the gadget.

The mandolin slicer 32 in this example also includes a deck height adjust mechanism described below. The mechanism generally has a user selectable adjustment device allowing a user to control slice thickness for the mandolin slicer 32. In one example, the device is a deck adjustment knob 70 on one side of the frame 36. As described below in greater detail, the deck adjustment knob 70 can be manipulated to change the elevation of the takeoff or pre-slice deck 56 of the upper tray 38 relative to the elevation of the cutting edge 52 on the blade 50. Thus, the thickness of slices to be produced by the mandolin slicer 32 can be adjusted by the user.

Also, a safety mechanism 72 is provided as a part of the mandolin slicer 32 in this example. Various safety features and functions of and provided by the safety mechanism are user-selectable or user-adjustable. In this particular example, the safety mechanism 72 generally has an actuator to actuate the safety mechanism as described herein. In one example, the actuator is a handle 74 for actuating a blade guard 76. The handle 74 is positioned at the rear end 48 of the frame 36 in this example. The blade guard 76 is positioned adjacent the cutting edge 52. The safety mechanism 72 also includes a user adjustable selection device for selecting and altering the safety mechanism functions. In one example, the selection device is a selection knob 78 positioned on a side of the frame 36 opposite the deck adjustment knob 70. The selection knob 78 is operable by a user to change and control various safety features and functions of the mandolin slicer 32. The safety mechanism 72 and safety features are described in greater detail below.

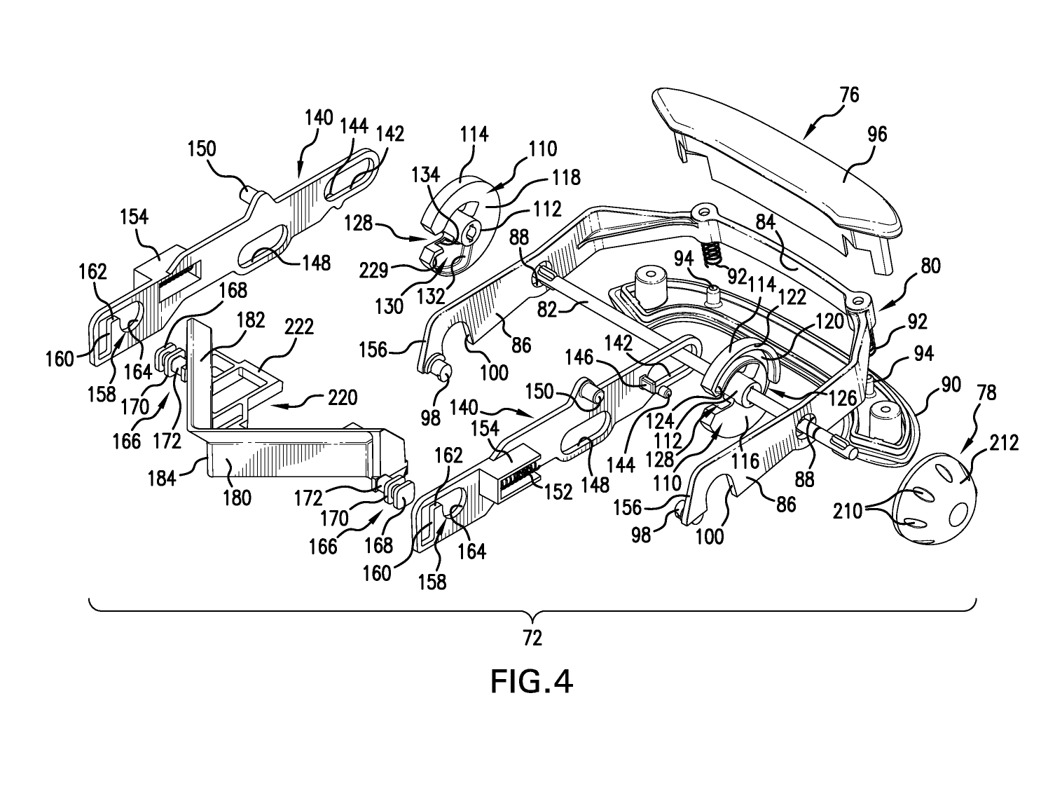

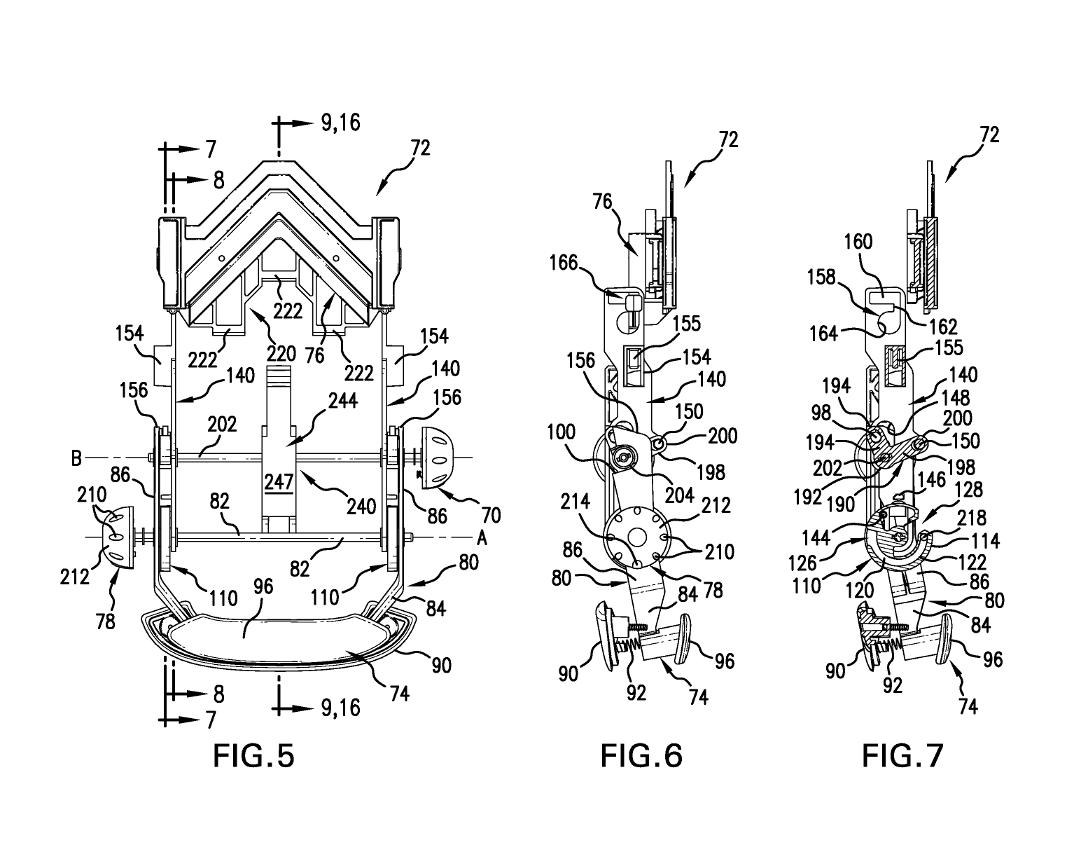

FIG. 4 illustrates the primary components of the safety mechanism 72 in this example. FIG. 5 illustrates nearly all of the components of the safety mechanism 72, as assembled, but with other parts of the mandolin slicer 32 removed for ease of illustration and description. With reference to these figures, the handle 74 is connected to a U-shaped carriage 80. The carriage 80 is secured to the frame 36 at a pivot axis A. A first axle 82 traverses the slicer 32 between side walls 81 on the frame 36. The carriage 80 can pivot about the axle 82 and, thus, the axis A. The handle 74 is secured to a crossbar 84 of the carriage 80. A pair of legs 86 of the carriage 80 extends forward from the crossbar 84, with the legs 86 spaced apart from one another across a width of the frame 36. A pivot opening 88 is located through about the midpoint of each of the legs 86. The axle 82 is aligned with these openings, which are thus also aligned with the axis A.

The crossbar 84 is positioned over a fixed part 90 of the frame 36 at the rear end 48 of the frame and extending between the side walls 81. Two springs 92 are slipped over bosses 94 that project up from the fixed part 90 of the frame 36. The springs 92 bias the crossbar 84 and handle 74 upward away from the fixed part 90. The handle 74 has a contact surface 96 that faces upward and that the user can press to actuate the handle 74. When the handle 74 of the mechanism 72 is actuated, the user presses on the contact surface 96. Such pressure compresses the springs 92, resulting in the handle and carriage crossbar 84 moving downward toward the fixed part 90 of the frame 36.

Each carriage leg 86 is essentially a mirror image of the other. Thus only one is described herein in further detail, whereby the other will have essentially the same construction. A drive pin 98 projects inward from a free end of the carriage leg 86 toward a like drive pin on the opposite leg across the span of the carriage 80. An upward extending clearance cut-out 100 is formed into the bottom edge of the leg 86. The selection knob 78 is secured to one end of the first axle 82 and in this example can be used to rotate the axle. The selection knob 78 has an outward facing surface 102 that is gripped by a user's fingers to rotate the knob as described below.

The safety mechanism 72 also has a pair of cam discs 110 carried on the axle 82, one each adjacent a respective one of the legs 86. Each cam disc 110 is also essentially a minor image of the other. Thus, only one cam disc 110 is described in detail herein, whereby the other cam disc will have essentially the same construction. The cam disc 110 has a central hub 112 coupled to the axle 82. The hub diameter is sized to closely fit within the opening 88 on the carriage leg 86, while allowing free rotation of the carriage leg about the hub 112. The cam disc 110 also has a perimeter edge 114, an outward directed outer face 116, and an inward directed inner face 118. The outer face 116 has a lock track 120 arranged circumferentially around a portion of the cam disc 110 adjacent the perimeter edge 114. The lock track 120 is essentially a recess in the outer face 116 that is created and bounded by a rib 122 protruding from the face. The lock track 120 has a closed end 124 at one end of the track. A gap or opening 126 in the rib 122 is positioned at the other end of the lock track 120. The gap 126 opens the other end of the lock track 120 radially outward to the perimeter edge 114.

A notch 128 is formed radially into the perimeter edge 114 of the cam disc 110. The notch 128 is positioned circumferentially generally opposite the gap or opening 126 of the lock track 120. The notch 128 is also positioned adjacent the closed end 126 of the lock track 120. The notch 128 opens to an inner track 129 positioned radially inward of the lock track 120. The inner track 129 extends circumferentially around the cam disc less of a distance than the lock track 120 in this example. The inner track also has a closed end 131 opposite the notch 128. A pocket 130 is formed as a recess on the inner face 118 of the cam disc 110. The pocket 130 is also bounded on three sides by a pocket wall 132. The pocket 130 has an opening 134 adjacent the notch 128 and the opening 134 is also open to the perimeter edge 114, similar to the lock track opening or gap 126. The pocket is positioned generally circumferentially opposite the closed end 131 of the inner track 129 and about the middle of the lock track 120.

The mechanism 72 also has a pair of elongate drive rods 140; one positioned on each side of the carriage 80 adjacent a respective one of the legs 86. Each of the drive rods 140 is also a mirror image of the other. Therefore, only one of the drive rods 140 is described in detail herein, whereby the other drive rod has essentially the same construction. The drive rod 140 has a cam slot 142 at its rear end. A cam pin 144 projects laterally outward from the drive rod 140 adjacent and below a forward end of the cam slot 142. A cam tab 146 also projects laterally outward from the drive rod 140 near the cam slot 142. The cam tab 146 is aligned with a lengthwise center of the forward end of the cam slot 142. The drive rod 140 also has a central slot 148 positioned at about the mid-point of the length of the rod. The cam slot 142 and central slot 148 are each oriented lengthwise along the drive rod 140 and permit lengthwise travel of the drive rod as is described below. A follower pin 150 is positioned above and spaced from the central slot 148 and also protrudes laterally outward from the rod. A spring 152 is captured within a three-sided box 154 that also protrudes laterally outward from the drive rod 140. The spring 152 is lengthwise oriented with one end borne against a surface of the box 154. An opposite end of the spring 152 is borne against a fixed surface (not shown) on the frame 36. The spring 152 biases the drive rod 140 in a forward direction away from the handle 74 and carriage crossbar 84.

A free end 156 of the adjacent leg 86 on the carriage 80 has a contoured guard track 158 formed through the leg. The guard track 158 has three segments in this example. One segment of the guard track 158 is a vertically oriented guard slot 160. An upper end of the guard slot 160 opens to a horizontal passage 162. The passage 162 extends rearward and opens to an access opening 164.

With reference to FIG. 4, the blade guard 76 has a pair of guide bosses 166 that project laterally outward in opposite directions from sides of the guard. The guide bosses 166 are identical to one another so only one is described herein. The guide boss 166 has a relatively large diameter head 168 on the end of the boss. The head 168 is spaced from a similarly sized and shaped washer 170 along the guide boss 166. A smaller diameter stem 172 of the boss 166 extends between and connects the head 168 and washer 170. The diameter or size of the head 168 and washer 170 are such that they can fit through the access opening 164 in the leg 86. The size of the passage 162 is such that the stem 172 can fit through the passage and into the vertical slot 160, but neither the head 168 nor the washer 170 can fit. Thus, the leg 86 is captured between the head 168 and washer 170. The stem 172 is sized to freely slide vertically along the guard slot 160. However, the head 168 and washer 170 are again wider than the width of the guard slot 160. Thus, the leg 86 remains loosely captured on the guide boss 166 within the guard slot 160.

The blade guard 76 in this example has a V-shape along a plane of the upper tray 38 and has a height perpendicular to the decks 56, 58. The blade guard 76 has a base wall 180 that is generally vertical or perpendicular to the plane of the deck surfaces. The blade guard 76 also has a guard wall 182 that projects upward from and is angled forward relative to a plane of the base wall 180. The earlier mentioned guide bosses 166 protrude outward from free ends of the base wall 180 spaced from a front apex 184 of the V-shape. The movement and function of the blade guard 76 is described in greater detail below.

Additional components of the mechanism 72 are now described with reference to FIGS. 5-8. The mechanism 72 includes a pair of drive levers 190, one for each side of the mechanism. Again, the levers 190 are essentially minor images of one another. Thus, one of the levers 190 and its function are described herein, whereby the construction and function of the other lever 190 is basically the same. The lever 190 is best illustrated in FIG. 7 and has a fulcrum or pivot 192. A drive link 194 extends radially outward from the fulcrum 192. A free end 196 of the drive link 194 has a hole in this example that is pivotally connected to the drive pin 98 of the respective leg 86 on the carriage 80. The lever 190 has a follower link 198 that is longer than the drive link 194 and that also extends radially from the fulcrum 192. The follower link 198 is oriented at an angle relative to, i.e., circumferentially spaced from, the drive link 194 about the fulcrum 192. A free end 200 of the following link 198 has a hole in this example that is pivotally coupled to the follower pin 150 on a respective one of the drive rods 140.

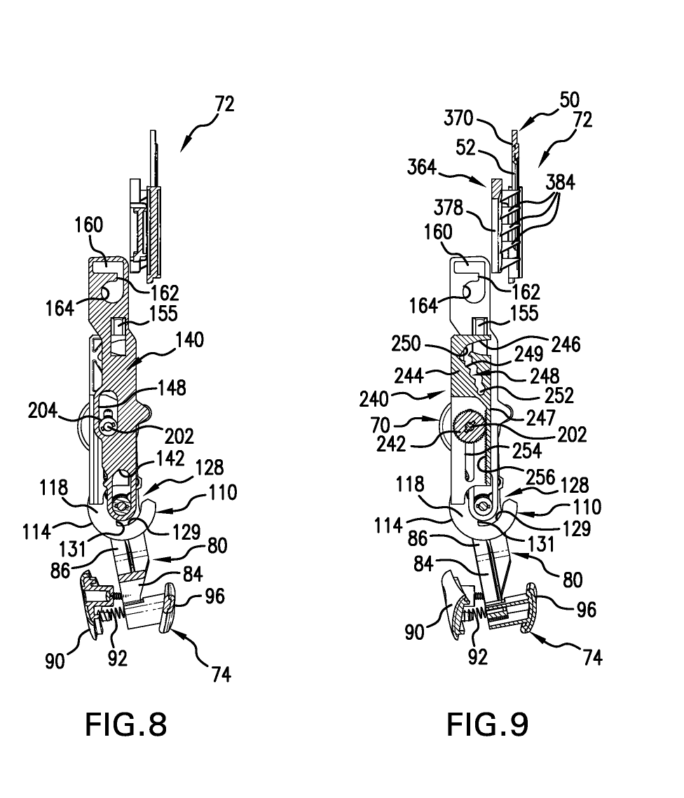

With reference to FIGS. 5-9, the deck adjustment knob 70 is connected to a second axle 202 that extends widthwise across the mechanism 72. The lever 190 has a hub 204 at and defining the fulcrum 192. The hub 204 protrudes axially outward in both directions from the lever 190. The second axle 202 is loosely received through the hub 204. Thus, the lever 190 pivots about a second axis B defined by the second axle 202. However, the lever 190 is not driven or rotated by rotation of the axle. An outer end of the hub 204 is aligned with the cutout 100 in the adjacent leg 86 on the carriage 80, as best seen in FIG. 6. An inner end of the hub 204 is seated in the central slot 148 of the adjacent drive rod 140, as best seen in FIGS. 7 and 8. The position of the second axle 202, the axis B, and the fulcrum 192 of the lever 190 are fixed by the frame 36. The drive rods 140 can move lengthwise fore and aft a distance permitted by the length of the central slot 148 and the position and diameter of the hub 204.

FIG. 6 shows a side view of the safety mechanism 72 depicted in FIG. 5. The function of the mechanism 72, its various components, and the corresponding safety features are again described, merely for ease of description, with reference to only the left side of the safety mechanism 72, which includes the selection knob 78. The function of the components on the other or right side of the safety mechanism 72 is essentially the same. The selection knob 78 and handle 74 control the relative position and orientation of components of the safety mechanism 72. The safety mechanism 72 can be moved and articulated to provide a number of safety features for the gadget 30.

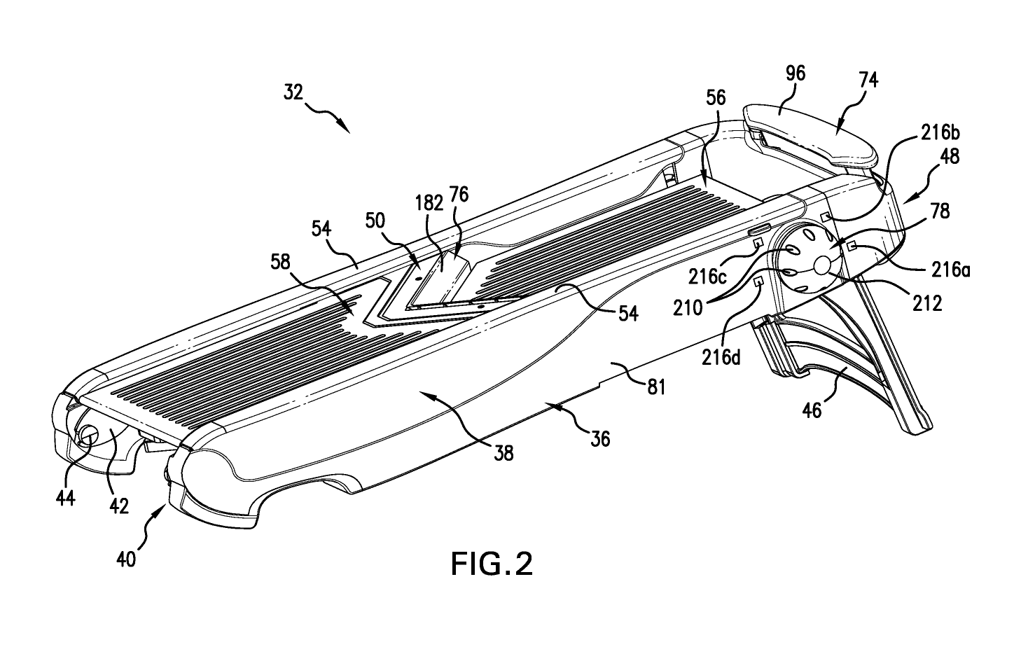

The selection knob 78 can have a plurality of dimples or protrusions 210 formed on its exposed gripping surface 212. These surface features can assist a user in grasping and manipulating the knob during use. One of the dimples or protrusions is larger than the others and is used herein as a reference indicator 214 to determine and select the rotational position of the selection knob 78. A plurality of position indicators 216a, 216b, 216c, and 216d (see FIG. 2) can be positioned on a surface of the frame 36 adjacent the selection knob 78. These indicators can correspond to selectable positions that are available for the knob. The selection knob 78 can be rotated among the plurality of user selectable positions to change the configuration and function of the safety mechanism 72, and thus the function and position of the blade guard 76 and the upper tray 38.

In FIGS. 5-9, the selection knob 78 is in a locked position or orientation and the safety mechanism 72 in a locked or storage mode. Specifically, the reference indicator 214 is directed toward the rear end 48 of the frame 36 and aligned with a first indicator 216a adjacent the knob. In the locked mode, the upper tray 38 is locked by the cam disc 110 and cannot be pivoted upward relative to the frame 36. In the locked mode, the drive rod 140 and the handle 74 are also locked in position and cannot be moved or actuated. In the locked mode, the blade guard 76 is thus also locked in a raised or blocking position preventing access or use to the cutting edge 52 of the blade 50.

Specifically, with reference to FIG. 7, in the locked mode the cam disc 110 is rotated to a position whereby its perimeter edge 114 blocks rearward movement of the stop tab 146 on the drive rod 140. The lever hub 204 is seated at the rear most end of the central slot 148 on the drive rod 140, as shown in FIG. 8. However, the drive rod 140 is prevented from moving in a rearward direction because the stop tab 146 hits the perimeter edge 114 of the cam disc 110. In this arrangement, the hub 112 of the cam disc 110 is also seated at the rear most end of the cam slot 142.

A tray peg 218 projects inward from the side of the upper tray 38. In the locked mode, the tray peg 218 is seated in the track 120 near the closed end 124 as shown in FIG. 7. The rib 122 of the track 120 captures the tray peg 218 in the track, preventing it from being raised above the track 120 and cam disc 110. This in turn retains the upper tray 38 in the in-use position on the frame 36, as shown in FIGS. 1-3.

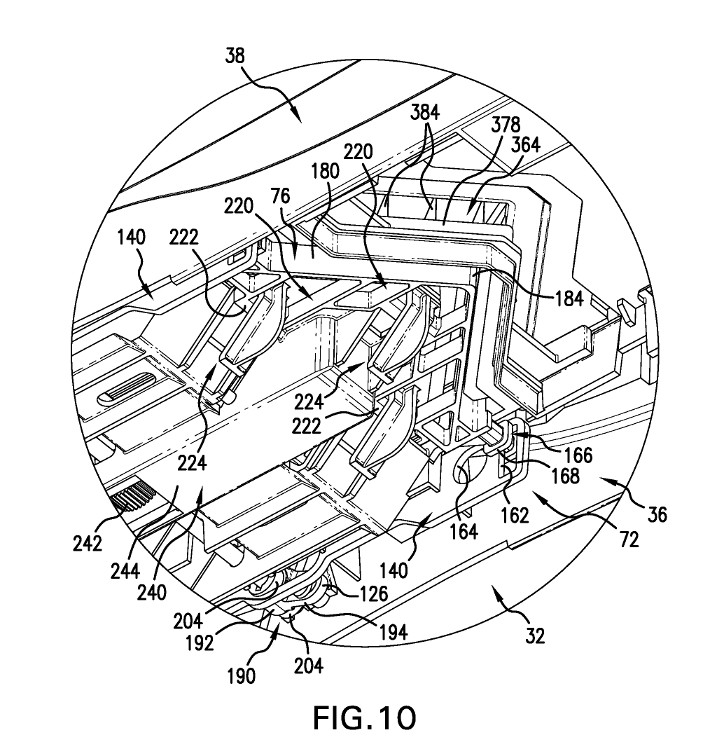

In the locked or storage mode, the blade guard 76 is retained in the raised or blocking position by the safety mechanism 72. Specifically, the guide boss 166 is positioned near the top of the guard slot 160, but slightly below the passage 162, as shown in FIGS. 6 and 10. The spring 152 biases the drive rod 140 in the forward direction. The springs 92 bias the handle 74 and thus the carriage crossbar 84 upward. This pivots the carriage 80 about the first axle 82 and thus the axis A, which in turn biases the free end 156 of the carriage leg 86 downward. This forces the drive pin 98 downward, which pivots the lever 190 counterclockwise in FIG. 6. The follower link 198 pulls the follower pin 150 forward, which pulls the drive leg 140 forward to the position as shown. The guide boss 166 is captured in the guard slot 160 and is thus pushed forward by the drive rod 140. This forces the blade guard 76 forward.

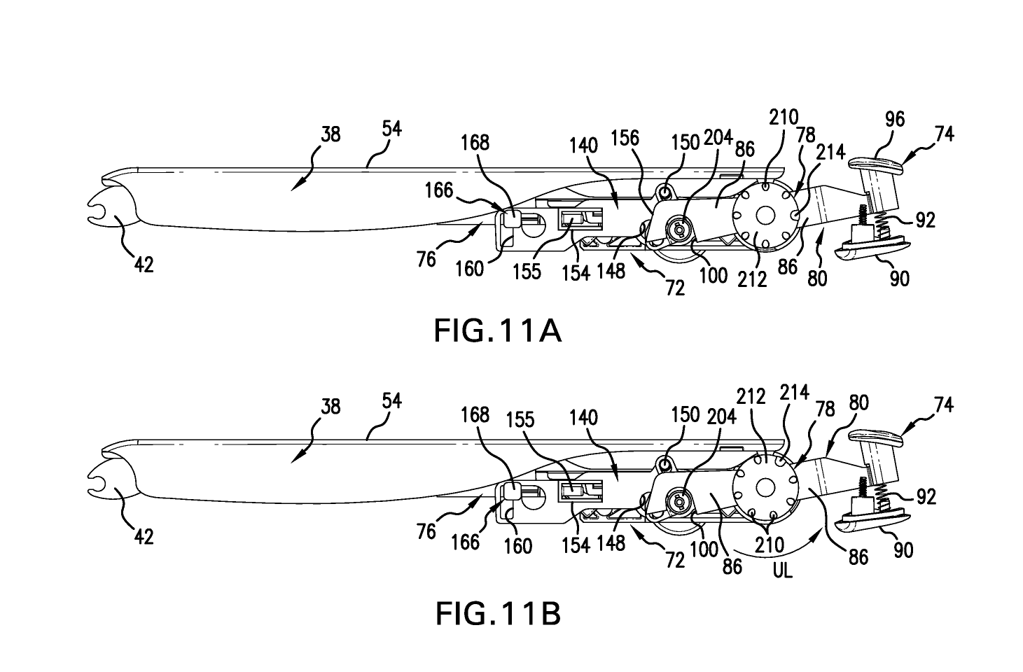

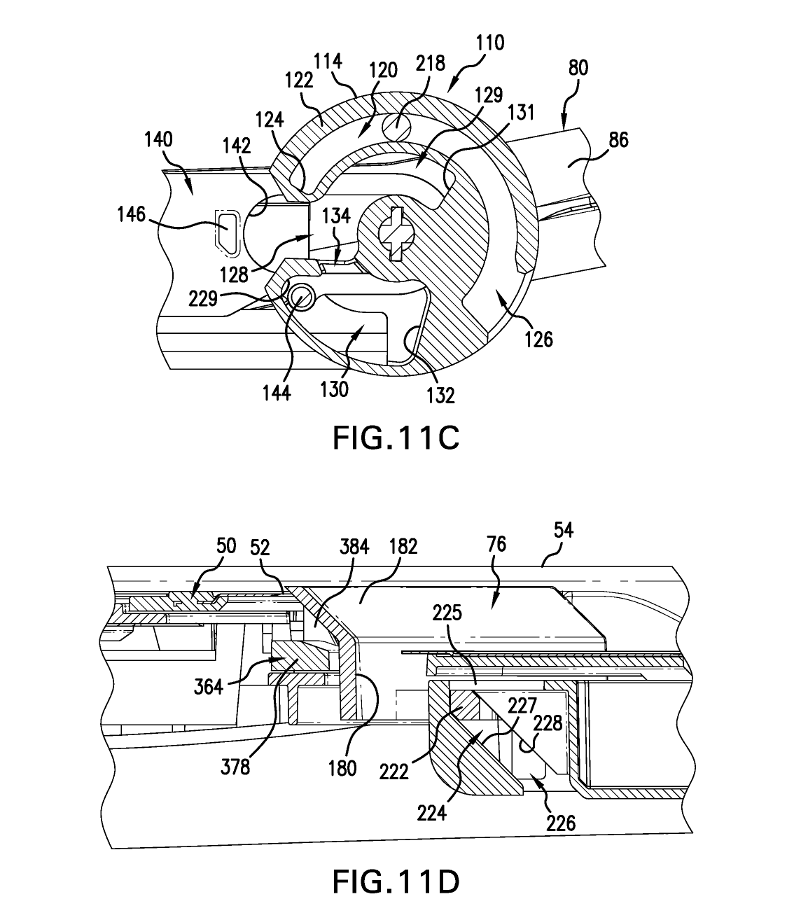

With reference to FIGS. 4, 5, and 10, the blade guard has a lattice framework 220 positioned behind and extending from the base wall 180. The lattice framework 220 can be provided to add rigidity and strength to the blade guard 76. However, in this example, the framework 222 also defines a pair of lift bars 222 that extend transversely spaced apart across the framework and that are aligned widthwise with one another. The lift bars 222 are captured within in corresponding ramp slots 224 provided on the underside of part of the frame 36. In the blocking position shown in FIG. 10, the lift bars 222 are positioned at a closed top end 225 of the ramp slots 224. Each of the ramp slots 224 is oriented such that the top end 225 is closer to the forward end 40 of the mandolin slicer 32 and a closed bottom end 226 of the ramp is closer to the rear end 48. As shown in FIG. 11D, each of the ramp slots 224 is defined between a pair of opposed, angled surfaces 227 and 228. One of the lift bars 222 is captured between the surfaces 227 and 228 in each of the ramp slots 224. In the locked mode as depicted in FIGS. 6-9, as the blade guard 76 is pushed toward the forward end 40 by the drive legs 140, the lift bars 222 are pushed in the forward direction and up the ramp slots 224 to the top ends 225. This lifts or raises the blade guard 76 to the blocking position, putting the guard wall 182 closely adjacent the cutting edge 52 of the blade 50. In the blocking position, the guard wall 182 covers the cutting edge 52 and prevents contact with the blade 50.

FIG. 11A shows the selection knob 78 in the locked position and the safety mechanism 72 in the locked mode. The safety mechanism 72 can be described as being in a blade guard up arrangement in the locked mode. The user can rotate the selection knob 78 counterclockwise, as shown in FIG. 11B by the arrow UL to the unlocked position or a blade guard ON position. In this position, the reference indicator 214 on the knob 78 is aligned with the second indicator 216b on the frame 36 adjacent the knob. None of the primary components of the safety mechanism 72 move, as indicated by comparing FIGS. 11A and 11B, when the knob is rotated from the locked position of FIG. 6 to the unlocked or guard on position of FIG. 11B. However, the cam disc 110 is connected to and rotates with the selection knob 78. As shown in FIG. 11C, the cam disc 110 rotates counterclockwise in concert with the selection knob 78. In the unlocked position, the notch 128 in the perimeter edge 114 of the cam disc 110 is aligned with the stop tab 146. This orientation of the cam disc 110 permits selective rearward movement of the drive rod 140, if the handle 74 were to be depressed, leaving the safety mechanism 72 in an unlocked mode with the knob in the unlocked position.

However, the configuration of the safety mechanism 72, other than the knob and cam disc orientation, does not change from the locked mode to the unlocked mode unless the handle 74 is depressed. The safety mechanism 72, including the handle 74, carriage 80, drive leg 140, and blade guard 76, thus remain in the guard up arrangement in the unlocked mode when the selection knob 78 is moved to the unlocked position of FIG. 11B. FIG. 11D shows a cross-section of the blade guard 76, blade 50, ramp slots 224, and lift bars 222, all still in the raised or blocking position. Without depressing handle 74, the blade guard still covers the cutting edge 52 of the blade 50, though the safety mechanism 72 is in the unlocked mode and the selection knob 78 is in the unlocked or blade guard ON position.

As shown in FIG. 11C, the tray peg 218 is also still captured in the track 120, though no longer adjacent the closed end 126, when the selection knob 78 is in the unlocked position. The peg 218 is still prevented by the rib 122 from exiting the lock track 120 vertically. As a result, the upper tray 38 is still locked to the frame 36 when the safety mechanism 72 is in the unlocked mode and the selection knob 78 is in the unlocked position.

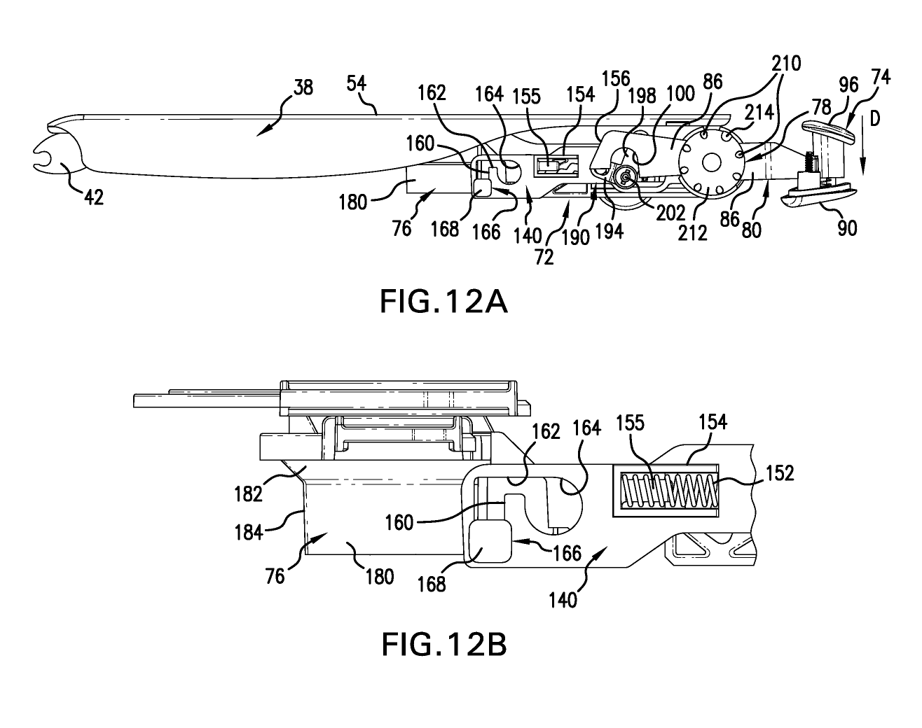

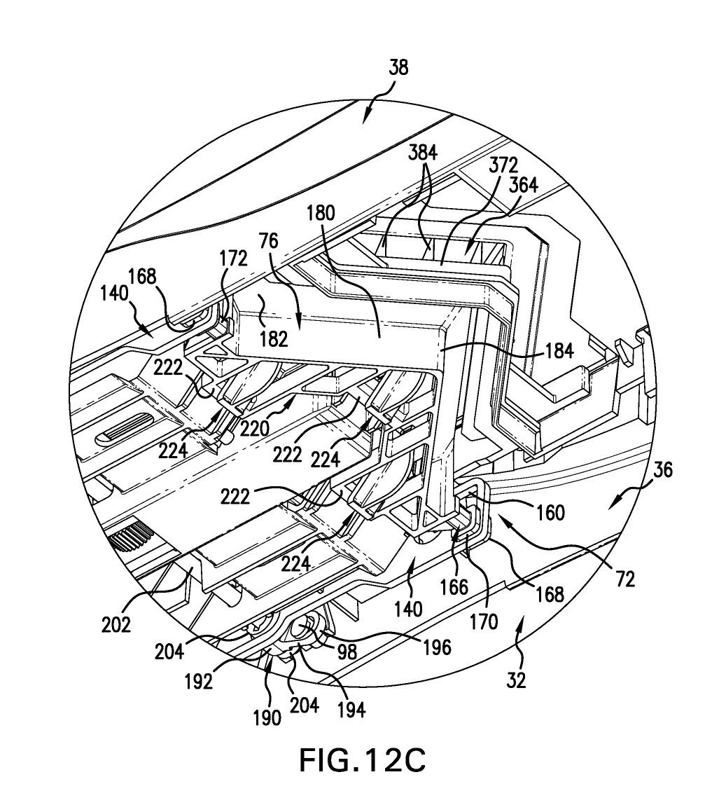

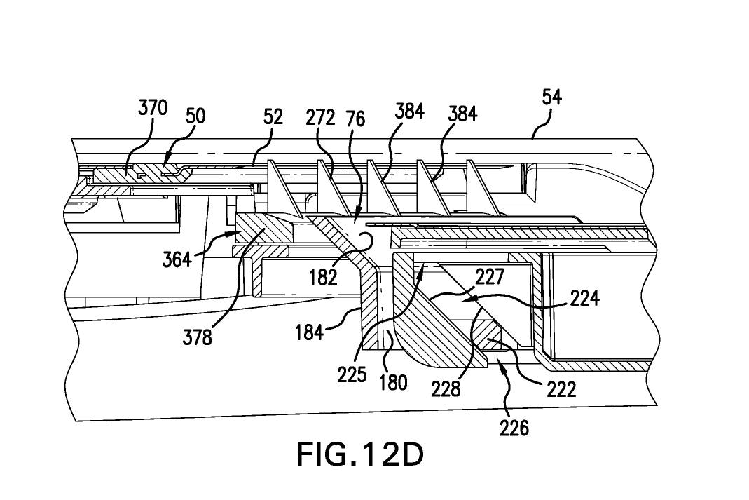

If the user wishes to slice food with the safety mechanism 72 in the unlocked mode depicted in FIGS. 11B-11D, the user must first actuate the handle 74. To do so, the user presses the handle 74 downward in the direction of the arrow D in FIG. 12A. The handle 74 moves against the bias of the springs 92 toward the fixed part 90 of the frame 36. Pushing the handle 74 downward also pushes the crossbar 84 of the carriage 80 downward. This in turn causes the leg 86 to pivot about the axis A, which raises the free end 156 of the leg and raises the drive pin 98 on the leg. The drive pin 98 pivots the drive link 194 on the lever 190 about the axis B. This pivots the lever 190, which in turn rotates the follower link 198 rearward toward the rear end 48 of the frame 36. The follower link 198 pulls the follower pin 150 and thus the drive rod 140 toward the rear end 48. With the notch 128 aligned with the stop tab 146, the tab travels into the notch 128 on the cam disc 110 when the handle 74 is depressed.

Moving the drive rod 140 rearward moves the guard slot 160 rearward. This also pulls or draws the guide boss 166 and thus the blade guard 76 rearward against the bias of the springs 152 acting on the drive bar 140. The lift bars 222 are guided rearward and downward by the ramp slots 224, causing the blade guard 76 to drop or be lowered to a slicing position. In the lowered, slicing position, the guide bosses 166 are seated near the bottom of the guard slots 166, as shown in FIGS. 12A-12C. The slicing position of the blade guard 76 is depicted in FIG. 12D. The guard wall 182 of the blade guard 76 is positioned below an elevation of the cutting-edge 52 of the blade 50, exposing the cutting edge for use. This configuration of the safety mechanism 72 can be described as the blade guard down arrangement.

With the selection knob 78 in the unlocked or blade guard ON position, the safety mechanism 72 in the unlocked mode, and the handle 74 depressed, the safety mechanism is in the blade guard down arrangement. In this arrangement, the hub 112 of the cam disc 110 moves from the rear most end to the forward most end of the cam slot 142 in the drive rod 140. Similarly, the hub 204 of the lever 190 travels from the rear most end of the central slot 148 to the forward most end. When the handle 74 is released, the springs 92 and 152 will respectively bias the handle 74 and carriage crossbar 84 upward and the drive rod 140 forward. This returns the blade guard 76 to the above-described blocking position and the safety mechanism to the blade guard up arrangement of the unlocked mode. The hub 112 and hub 204 will return to be seated at the rear most ends of the respective slots 142 and 148. The diameter of the hubs of the cam disc 110 and lever 190 and length of the slots 142, 148 in the drive bar 140 can act as travel limiters in both directions of movement for the safety mechanism 72.

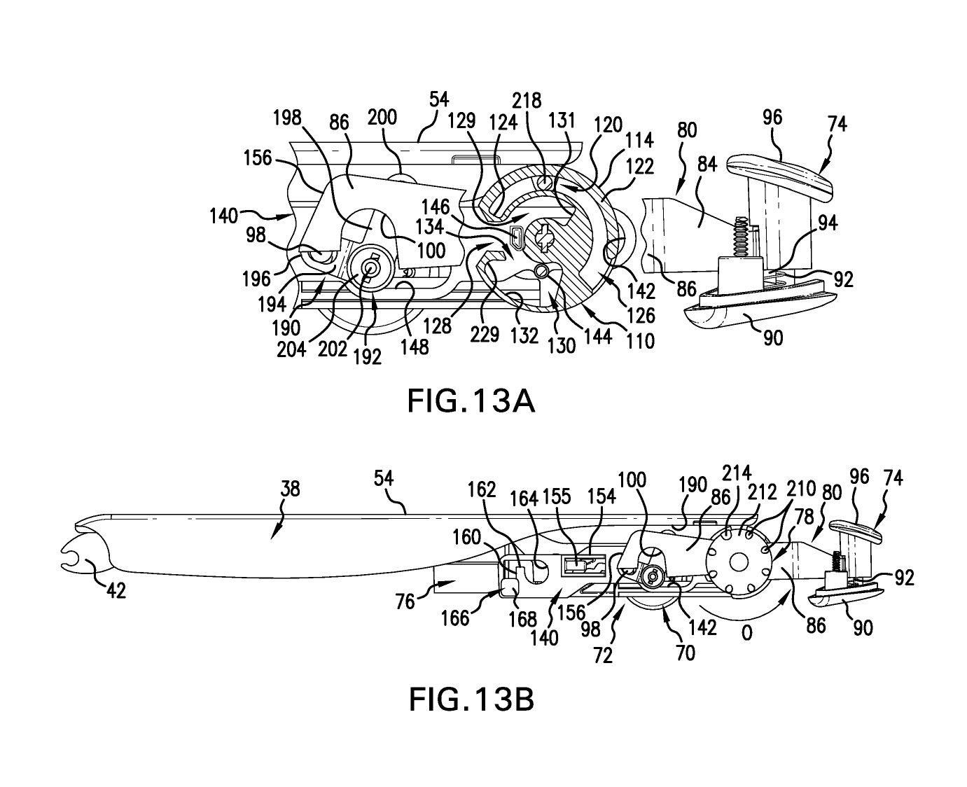

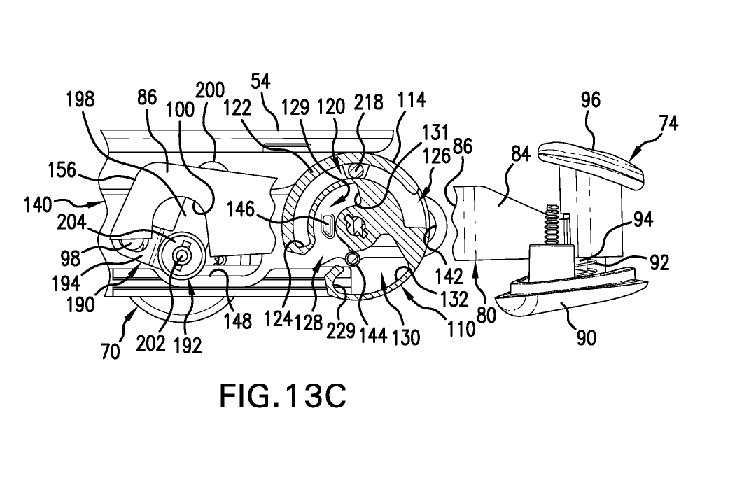

Returning to FIG. 11C, the selection knob 78 can not be further rotated counterclockwise with the handle 74 released. The selection knob 78 can only be rotated back to the locked or storage position. With the handle 74 released, the cam pin 144 is seated in the pocket 130 and borne against a stop portion 229 of the pocket wall 132. Further rotation of the knob 78 in a counterclockwise direction is prevented by contact between the cam pin 144 and the stop portion 229. With reference to FIG. 13A, when the handle 74 is depressed, the cam pin 144 is drawn rearward and aligned vertically beneath the pocket opening 134 in the cam disc 110. Similarly, the stop tab 146 is positioned within the notch 128 and aligned beneath the inner track 129.

With reference to FIG. 13B, the selection knob 78 can be rotated further counterclockwise in the direction of the arrow 0 to a guard OFF position, but only when the handle 74 is depressed. In the guard OFF position, the reference indicator 214 is aligned with a third one on the position indicators 216c on the body 36 adjacent the knob. As shown in FIG. 13C, the stop tab 146 is captured within the inner track 129 with the knob 78 rotated to the guard OFF position. Similarly, the cam pin 144 is positioned within the pocket opening 134 beneath the hub 112 of the cam disc 110. However, with the selection knob 78 in this position, the upper tray 38 is still locked onto the frame 36. The tray peg 218 is still captured within the lock track 120 and prevented from upward movement by the rib 122.

In the blade guard OFF position, the safety mechanism 72 is maintained in the blade guard down arrangement. Specifically, the handle 74 is held in the depressed position even if the user releases their grip on the handle or pressure on the contact surface 96. As a result, the blade guard 76 is also retained in the lowered slicing position depicted in FIGS. 12C and 12D. This configuration of the safety mechanism 72 can be selected by experienced users and professional chefs, if they choose to use the gadget 30 without having to continuously press and hold the handle 74. The blade guard 76 is held in the lowered or slicing position by the safety mechanism 72. Less experienced users can choose to operate the gadget 30 in the manual mode whereby the user must depress and hold the handle 74 down while slicing food.

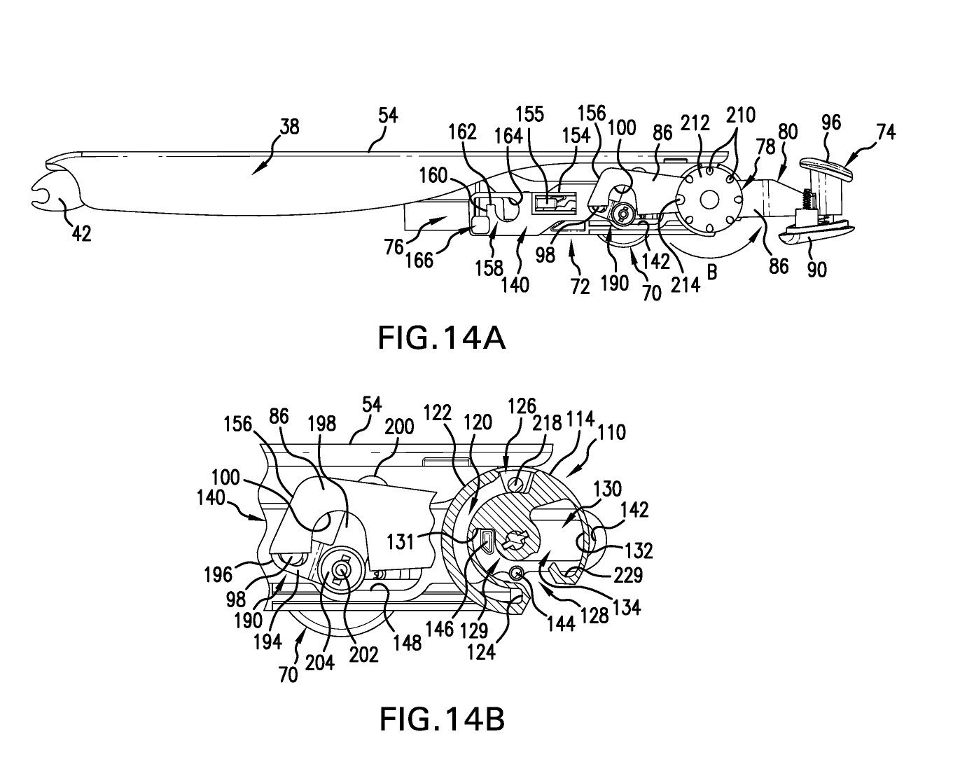

The selection knob 78 can be further rotated counterclockwise in the direction of the arrow B to a blade change position as depicted in FIG. 14A. In this position, the reference indicator 214 is directed toward the forward end 40 of the mandolin slicer 32 and is aligned with the last of the position indicators 216d on the frame surface. FIG. 14B shows the cam disc 110 with the selection knob 78 in the blade change position 78. In this position, the stop tab 146 is still captured in the inner track 129 adjacent the closed end 131 on the cam disc 110. The cam pin 144 is also now positioned at the open end of, or entry to, the inner tack 129. Thus, the safety mechanism 72 will still be maintained in the blade guard down arrangement with the blade guard 76 in the lowered, slicing position.

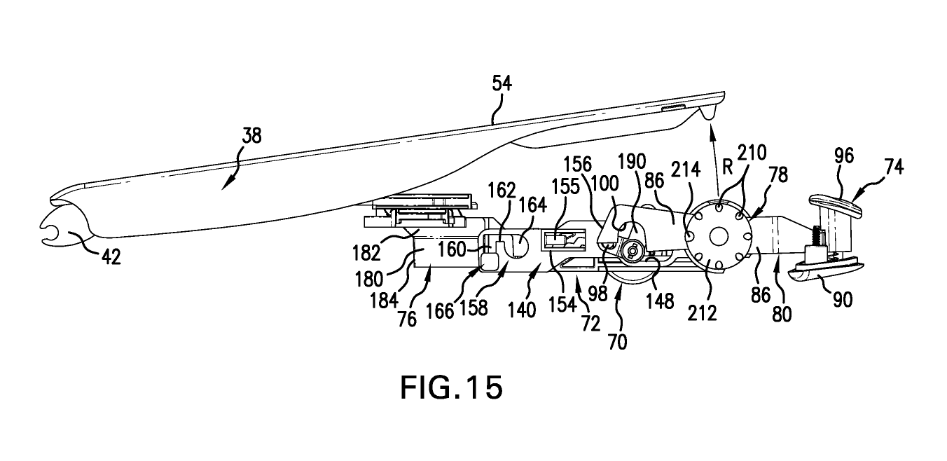

However, the open end 126 of the lock track 120 is now facing upward, aligned with the tray peg 218 on the upper tray 38, as shown in FIG. 14B. The upper tray 38 can now be raised from the frame 36, pivoting about the pins 44 at the forward end 40 of the tray, as shown in FIG. 15. With the upper tray raised, storage compartments and receptacles (not shown) within the frame can be accessed. In addition, the blade 50 is accessible and can be removed and replaced as desired. Additional replacement blades or optionally selectable different food preparation blades can be stored within the mandolin slicer 32 and accessed as needed with the safety mechanism 72 in the blade change mode and the upper tray 38 pivoted up from the frame 36.

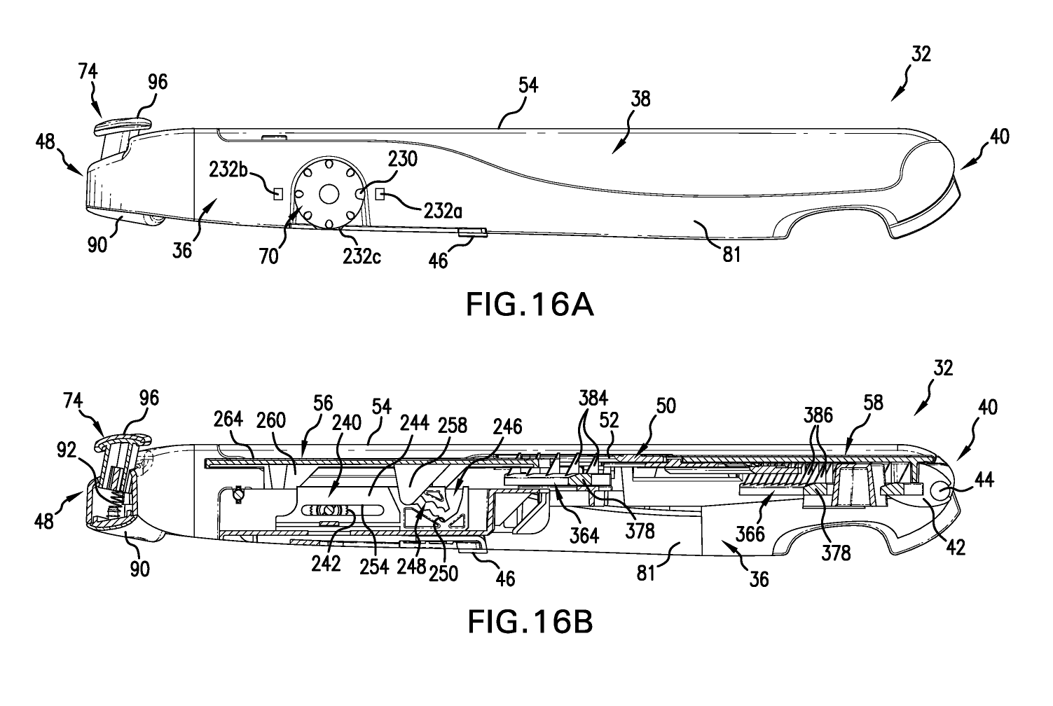

FIG. 16A shows the opposite side of the mandolin slicer 32, and specifically illustrates the deck adjustment knob 70. In this example, the deck adjustment knob 70 also has a reference indicator 230 and can be rotated to selectively align the knob with various indicators 232a, 232b, and 232c surface of the frame 36 adjacent the adjustment knob 70. In this example, the adjustment knob 70 raises or lowers the pre-slice or take-off deck 56 relative to the elevation of the cutting edge 52 on the blade 50. By doing so, slices of different thickness can be produced by the mandolin slicer 32. As shown in FIG. 16A, the reference indicator 230 is positioned in a forward facing direction aligned with a first one of the indicators 232a, representative of a minimum slice thickness position for the deck adjustment knob 70.

FIGS. 5 and 9 illustrates components of a height adjustment mechanism 240 for raising or lowering the pre-slice deck 56. The mechanism 240 in this example employs a rack and pinion gear system including a pinion gear 242 mounted at about the center of the second axle 202 for rotation therewith. A hoist or elevator 244 is positioned centrally between the side walls 81 of the frame 36. The hoist 244 is a box-like structure with a contoured opening extending laterally side to side through the body of the hoist. The contoured opening has an entry slot 246 formed downward from a top surface 247 into the hoist and near the forward end of the hoist. The entry slot 246 transitions rearward into a stepped ramp 248 defining a plurality of steps 249 facing upward and forward. The stepped ramp 248 has a lower end 250 that is open and transitions to entry slot 246. The stepped ramp 248 extends rearward and rises to an upper end 252 that is closed. The upper end 252 is at a higher elevation than the lower end 250 and further rearward of the entry slot 246.

The hoist 244 also has a travel slot 254 that is lengthwise oriented through the body of the hoist. The second axle 202 extends through the travel slot 252 across the width of the frame 36. The hoist 244 can move fore and aft lengthwise within the limits of the travel slot 2. A rack gear 256 is formed on a downward facing surface of the body of the hoist 244. The pinion gear 242 has teeth that engage teeth on the rack gear 256. Rotation of the pinion gear 242 moves the rack gear 256, and thus the hoist 244 in a lengthwise direction. The pinion gear 242 is mounted to the second axle 202, which is mounted to the frame 36 at a fixed location. Thus, the pinion gear 242 is stationary, other than rotating about the axis B, and the rack gear 256 moves when the adjustment knob 70 is rotated.

As shown in FIG. 16B, the pre-slice deck 56 has a plurality of standoffs or support legs that project downward from the bottom of the deck. A central one of the standoffs 258 has a projection (not shown) received through the stepped ramp 248 in the hoist 240. With the deck adjustment knob 70 in the minimum slice thickness position, the pre-slice deck 56 is raised or and a maximum height position. In this position, the projection of the central standoff 258 is positioned at the upper end 252 of the stepped ramp 248. The pre-slice deck 56 is at very close to, but slightly below, the elevation of the cutting edge 52 of the blade 50. The difference in elevation between the cutting edge 52 and the top surface 259 of the deck 56 defines a thickness of the sliced food item that will be produced by the mandolin slicer 32.

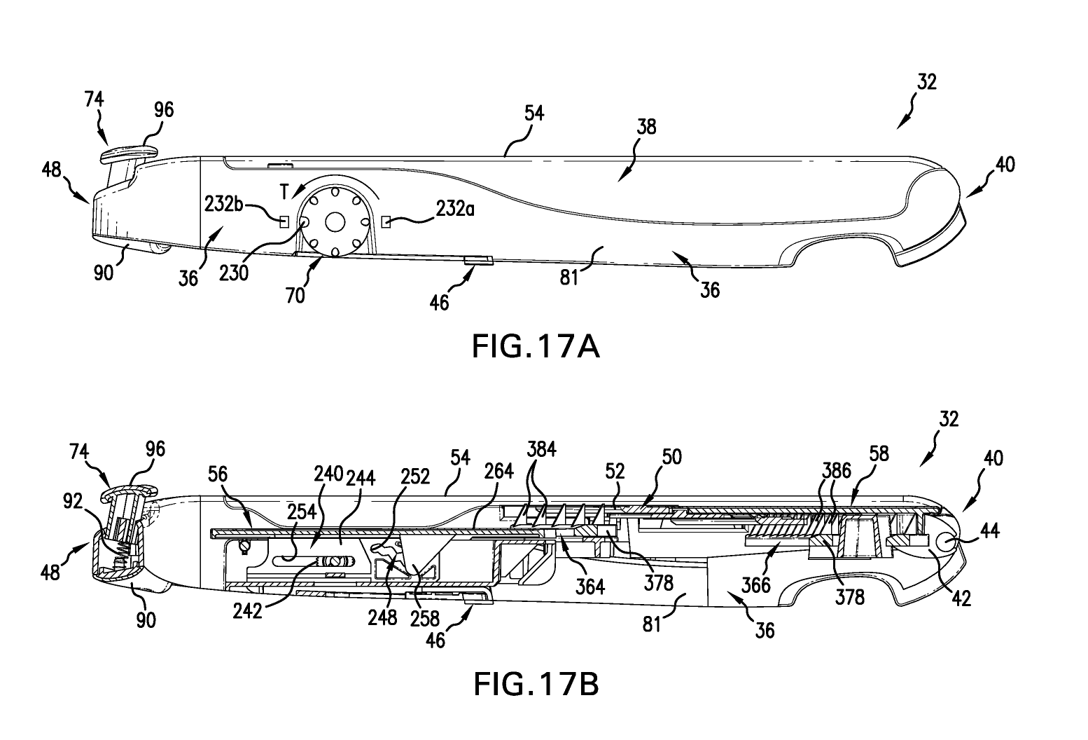

As shown in FIG. 17A, the adjustment knob 70 can be rotated counterclockwise to at least a second position with the reference indicator 230 aligned with a second one of the indicators 232b. In this example, the second indicator 232b faces directly rearward and is representative of a maximum slice thickness position of the adjustment knob 78 and elevation of the pre-slice deck 56. With the adjustment knob 70 in the maximum slice thickness position, the pre-slice deck 56 is lowered to a minimum height position.

As the adjustment knob 70 is rotated counterclockwise in the direction of the arrow T, the pinion gear 242 will also rotate counterclockwise. This in turn will drive the rack gear 256 and the hoist 244 rearward. In doing so, the stepped ramp 248 will also move rearward, resulting in the projection on the central standoff 258 moving down the steps 249 of the stepped ramp 248. In the maximum slice thickness position, the projection of the central standoff 258 is positioned at the lower end 250 of the stepped ramp 248. As shown in FIG. 17B, this drops the pre-slice deck 56 to the minimum deck height relative to the cutting edge 52 of the blade 50.

Reverse rotation of the adjustment knob 70 will move the rack gear 256 and hoist forward, which will cause the projection of the standoff 258 to rise up the stepped ramp 248. Though not shown or described herein, additional standoffs 260 can also depend from the bottom of the pre-slice deck 56. These additional standoffs 260 can each have a projection 262 protruding therefrom, similar to the central standoff 258. These projections 260 can bear against and ride along ramp surfaces (not shown) on the underside of the frame 36 as the pre-slice deck 56 is raised or lowered. These additional standoffs 260 can help guide the pre-slice deck 56 as its height is adjusted and can help maintain the deck in a stable condition and a level or parallel orientation relative to a top surface on the landing deck 58.

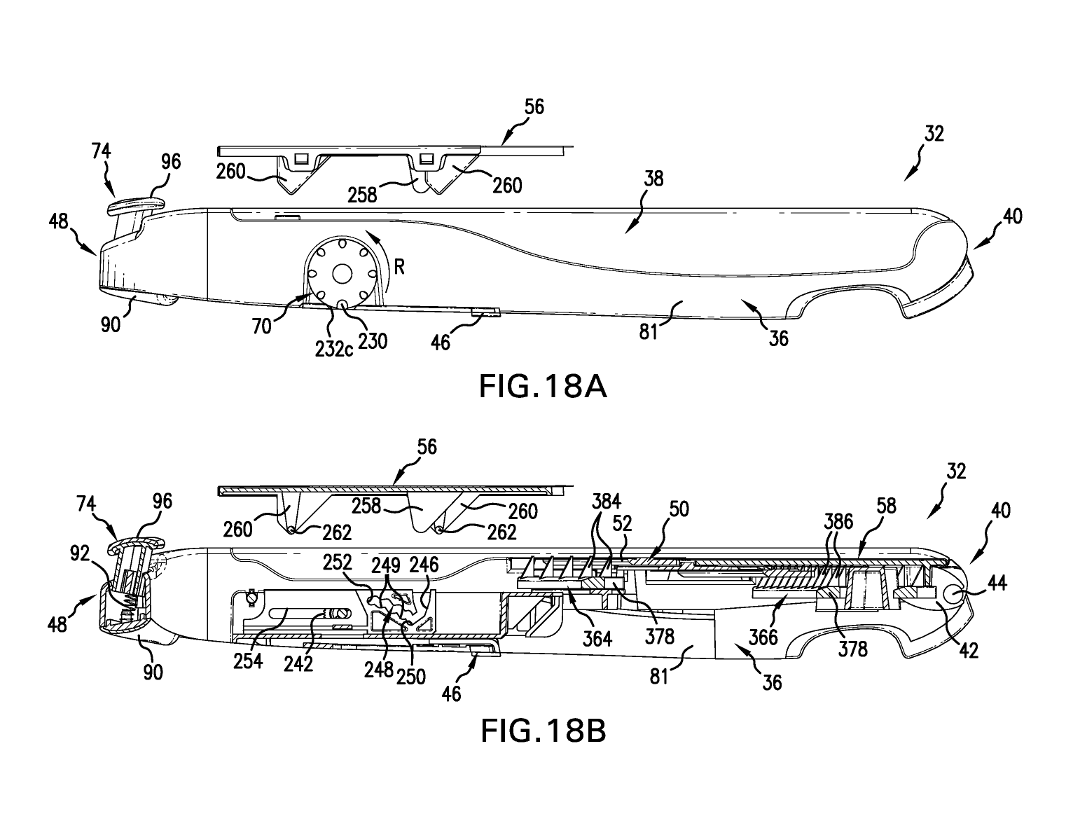

The deck adjustment knob 70 can be further rotated counterclockwise in the direction of the arrow R as shown in FIG. 18A until the reference indicator 230 is aligned with the third of the indicators 232c, which is oriented straight downward in this example. The pinion gear 242 rotates counterclockwise, which drives the hoist 244 further rearward until the projection on the standoff 258 is in the bottom of the entry slot 246 on the hoist 244. In this arrangement, the pre-slice deck 56 can be removed as shown in FIG. 18B from the frame 36 and the upper tray 38. The pre-slice deck 56 can be removed in order to gain access to additional storage under the upper tray 38 or gain access to the height adjust mechanisms 240 and safety mechanism 72 for cleaning and/or repair.

As will be evident to those having ordinary skill in the art, additional positions and indicators for the deck adjustment knob 70 can be provided, at least between the minimum and maximum height position indicators. The steps 249 on the stepped ramp 248 can vary in number and can represent interim adjustment heights for the deck 56. Similarly, additional positions and indicators can also be provided for the selection knob 78, if the safety mechanism is designed to provide additional safety features or other features as desired.

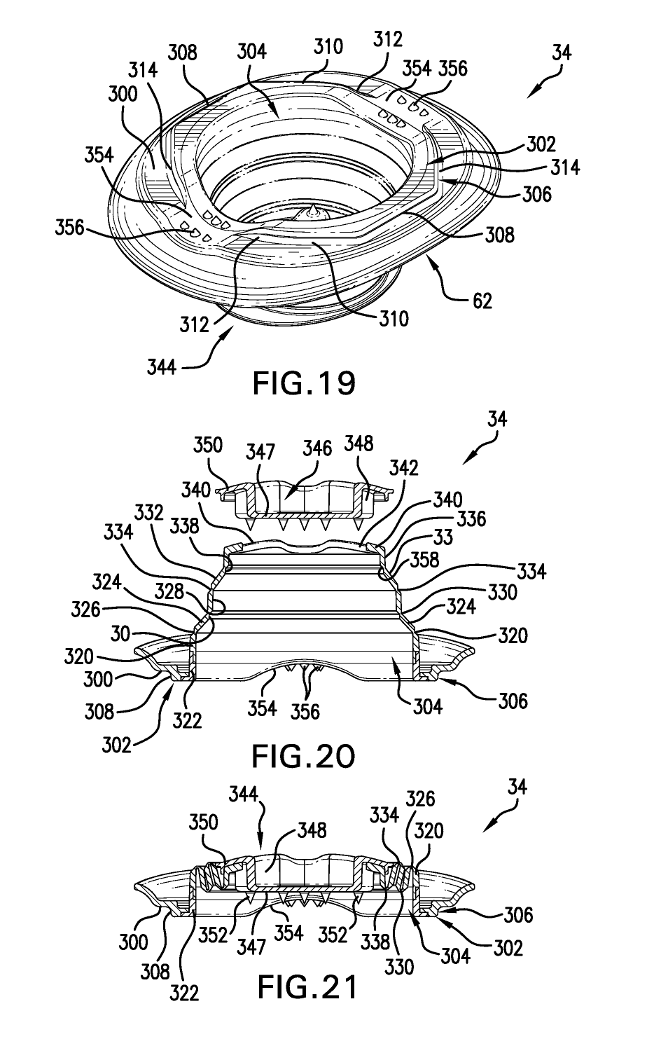

Another aspect of the present invention is illustrated with reference to FIGS. 19-21. The pusher 34 is shown in an inverted orientation in FIG. 19. A bottom surface 300 of the rim flange 62 has a shaped protrusion 302 protruding downward from the bottom surface. The shaped protrusion 302 also surrounds an opening 304 into an interior of the grip portion 60. A perimeter surface 306 of the protrusion 302 is octagonal and defines four opposed pairs of generally linear sides 308, 310, 312, and 314. In this example, each of opposed pair of sides on the protrusion 302 is sized to generally fit between the side rails 54 on the upper tray 38 and yet prevent the pusher 34 from rotating, once resting on the upper tray top surfaces. This allows the user to orient the pusher 34 in any one of four rotational orientations as desired during use. In one example, one of the pairs of sides 312 can have rounded corners or transitions between the adjacent pairs of sides 310 and 314. In such an example, the pusher may be rotated from one orientation with the side 310 adjacent the side rails 54 to another orientation with the sides 314 adjacent the side rails while the protrusion rests on the upper tray 38. In such an example, the pusher would define three defined orientations for use corresponding to the sides 308, 310, and 314 being adjacent the side rails 54. The sides 312 would allow use in any orientation between the sides 310 and 314, offering further options and comfortable positions for the user from which to select.

Also as shown, the rim flange 62 does not have a circular configuration, but instead has an oblong configuration. Depending on the orientation of the pusher 34 in the user's hand on the grip portion 60, more or less of the rim flange 62 will overhang the side rails 54 and the more or less of the rim flange will extend in a forward or rearward direction along the upper tray 38 during use. Thus, the user can orient the pusher 34 according to their comfort level during use of the kitchen gadget 30. Because the protrusion 302 rests on the upper tray during use, the bottom surface 300 of the rim flange 62 is elevated above the side rails 54. The rim flange 62 thus offers protection for a user's hand and fingers during use, but does not negatively affect performance. The rim flange 62 is not seated between the side rails 54 but is instead elevated above the side rails, eliminating any chance of the rim flange creating friction to inhibit motion of the pusher during use.

As shown in FIG. 20, the grip portion 60 has a generally tapered, conical shape with ring segments that gradually become smaller in diameter moving from bottom to top. A first ring segment 320 has an essentially annular, vertical wall orientation. An upstanding lip 322 on the rim flange 62 surrounds and defines the opening 304 therein. The first ring segment 320 is connected to an upper edge of the lip 322. In one example, the rim flange 62 can be formed of a substantially hard or rigid plastic material such as polycarbonate. The grip portion 60 can be formed of a flexible or resilient material such as thermoplastic elastomer, rubber, or the like. The first ring segment 320 of the grip portion 60 can be adhered to the upstanding lip 322 in any suitable manner, such as by rotational welding, heat welding, use of dual or insert molding techniques, adhesives, or the like. In addition, the materials used to fabricate the rim flange 62 and the grip portion 60 can vary from the examples described herein.

A second ring segment 324 is connected to the upper edge of the first ring segment 320. The second ring segment 324 is angled or tapered inward from bottom to top defining a conical shape. The wall thickness of the material connecting the first and second ring segments is thinner than the wall thickness of the adjacent material. The thin walled portion between the segments forms a first living hinge or collapsible fold joint 326 between the first and second ring segments.

A third ring segment 328 is connected to the upper edge of the second ring segment 324 at a second living hinge 330. Third ring segment 328 has a smaller diameter than the first ring segment 320 but also has an annular, vertical wall orientation. A fourth ring segment 332 is connected to the upper edge of the third ring segment 328 at a third living hinge 334. The fourth ring segment 332 is smaller in diameter than the second ring segment 324, but is also angled or tapered inward from bottom to top defining a conical shape. A fifth ring segment 336 is connected to the upper edge of the fourth ring segment 332 at a fourth living hinge 338. The fifth ring segment 336 is smaller in diameter than the third ring segment 328, but also has an annular, vertical wall orientation. A top wall 340 of the grip portion 60 is connected to the upper edge of the fifth ring segment 336 and defines the top of the grip portion. A top opening 342 is formed in the top wall 340. In this example, the top opening 342 is generally star-shaped.

As shown in FIG. 20, the pusher 34 has a removable top cap 344. In this example, the top cap 344 has a hollow body 346 with a closed bottom 347 and an upstanding sidewall 348. The body shape defined by the sidewall 348 is also generally star-shaped and matches the configuration of the top opening 342. The body 346 seats in the top opening 342 in the top wall 340 of the grip portion 60 when installed on the pusher 34 (see FIG. 21). The top cap 344 has a rim 350 that extends radially outward from the top edge of the sidewall 348. The rim 350 rests on the top wall 340 of the pusher 34 when the top cap is installed. Though not shown herein, a plurality of bumps or detents can be provided on the exterior surface of the sidewall 348 to help removably secure the top cap 344 within the top opening 342 when installed on the pusher 34.

As shown in FIG. 20, the top cap 344 is removable from the pusher 34. This allows a user to use the gadget 30 to slice elongate food items such as celery, carrots, and the like while held in a vertical orientation. A portion of the these elongate food items can extend up into the interior of the grip portion 60 of the pusher 34 and out through the top opening 342 with the top cap 344 removed.

As shown in FIGS. 19 and 20, the underside of the bottom surface 347 on the top cap 344 can include a plurality of spikes 352 or the like protruding downward to help grip food items retained within the interior of the pusher during use. Likewise, a pair of upward or concave recesses 354 is provided in surfaces of the protrusion 302. The recesses 354 are aligned in a lengthwise direction with one another relative to the oblong shaped rim flange 62 on the pusher 34. A plurality of spikes 356 are provided protruding downward within these recesses 354, also for gripping food held by and under the pusher 34. The recesses 354 in this example position the spikes 356 so they do not protrude below an elevation of the protrusion 302, which would rest on the deck or upper tray surfaces during use of the slicer 32.

The unique configuration of the ring segments on the grip portion 60 of the pusher 34, as well as the flexible and resilient nature of the material used to form the grip portion, allow the pusher to collapse as shown in FIG. 21. The hinges 326, 330, 334, and 338 allow the various adjacent ring segments to collapse onto and radially inward of one another as shown to reduce the height of the grip portion 60. The grip portion 60 can be collapsed to make the pusher smaller for storage when the gadget 30 is not being used. Alternatively, or in addition, the grip portion 60 can collapse to further accommodate the changing size of food items being sliced and retained on the interior of the pusher 34. As a food item is sliced from the bottom, the item will become shorter in height. The user can continue to push downward on the grip portion 60, keeping it in contact with the food item for efficient and continued slicing. As the food item becomes shorter in height, the grip portion 60 can accommodate this change by gradually collapsing in concert with the food item.

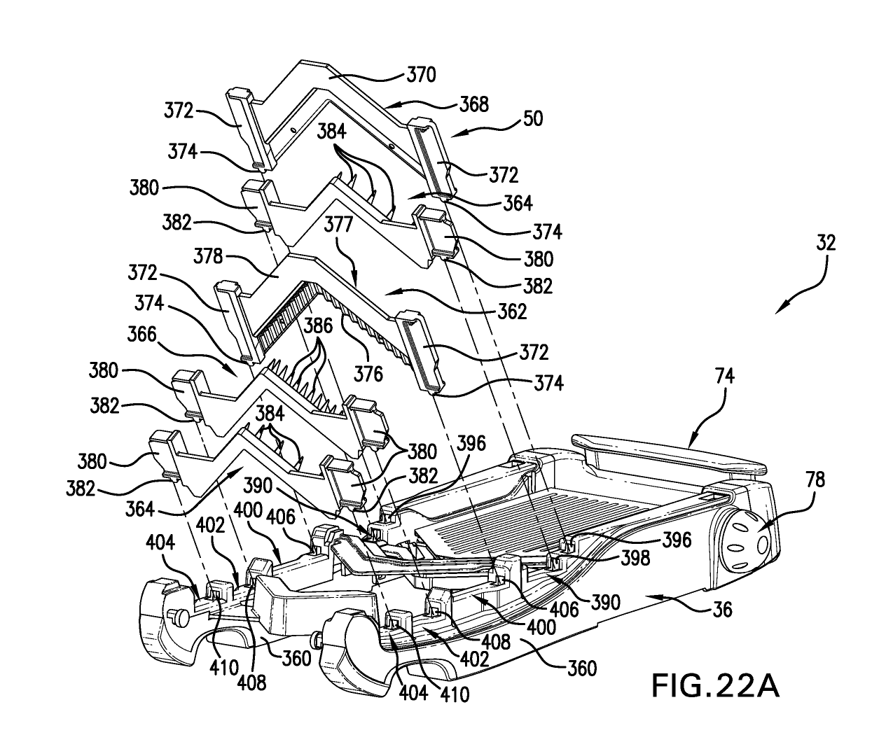

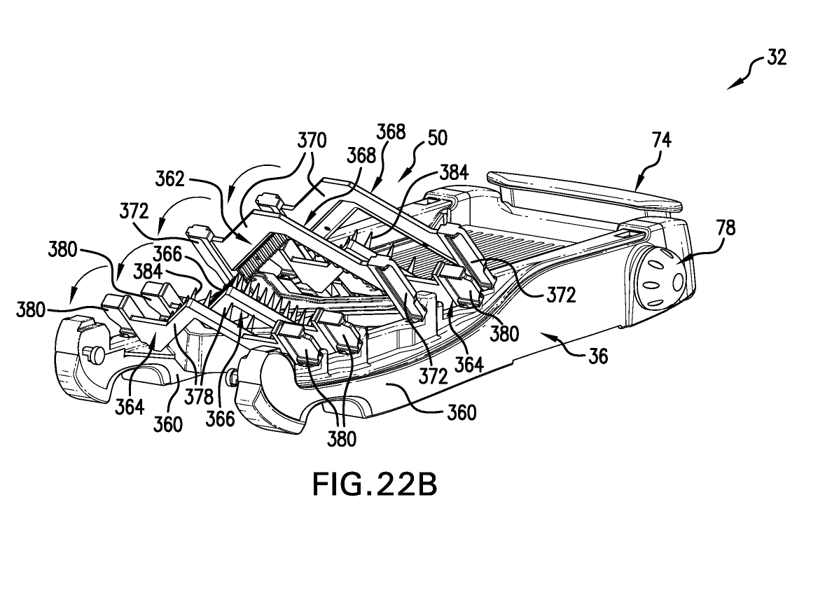

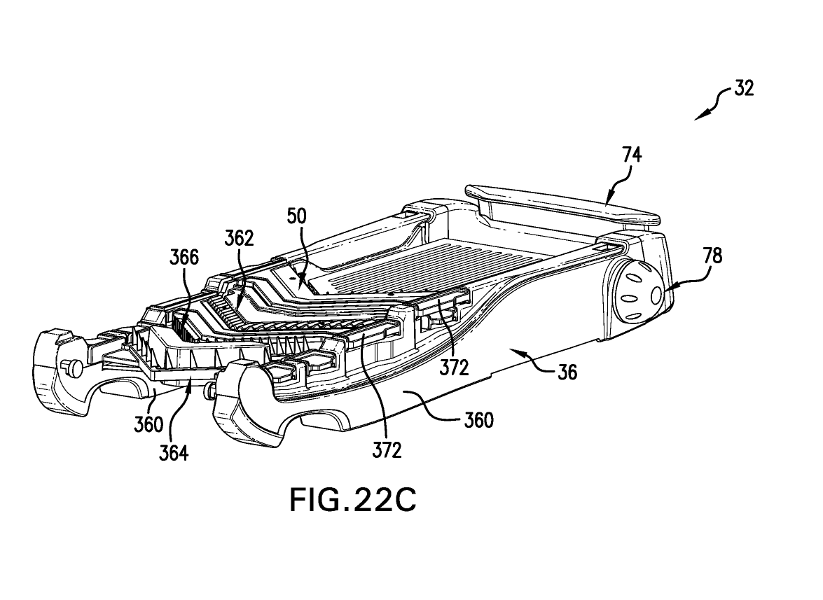

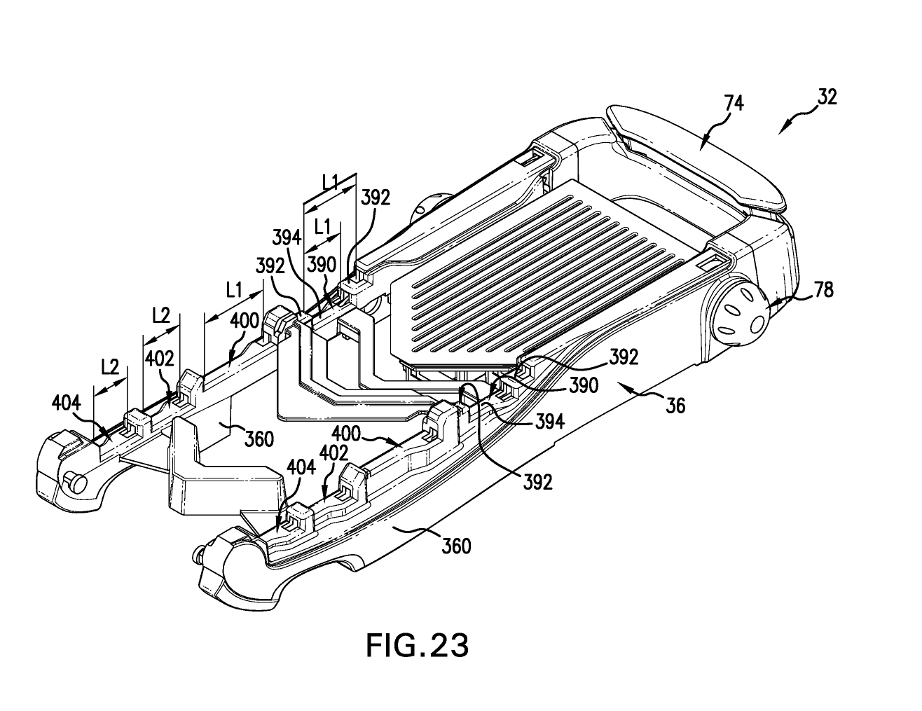

FIGS. 22A-23 illustrate yet another aspect of the kitchen gadget 30 disclosed and described herein. In this example, the frame 36 beneath the upper tray 38 is formed having a plurality of blade storage pockets. The frame 36 has a pair of spaced apart sides 360 that coincide with the side rails 54 of the upper tray 38. A plurality of pairs of the storage pockets are formed across the frame in each side 360. The slicer 32 can also be provided with a plurality of replacement and/or optional cutting blades, including the linear or straight cut blade 50 described above. The plurality of blades in one example can also includes a waffle blade 362, a first julienne blade 364, and a second julienne blade 366 having different blade spacing than the first julienne blade. Each of the blades can be inserted for use or storage in one of the pairs of pockets as described below.

The blade 50 has a body or carrier 368 with a V-shaped, widthwise oriented midsection 370 extending across the blade that carries the cutting edge 52. The carrier 368 also has a pair of lengthwise oriented supports or feet 372, one on each end of the midsection 370. The feet 372 each have a first length, the purpose of which is described below. A rear end of each of the feet 372 has a nub 374 protruding rearward therefrom. The waffle blade 362, instead of having a linear or flat cutting edge 52, has a corrugated shape defining a serpentine cutting edge 376. Otherwise, the waffle blade 362 has an identical carrier 368, including the midsection 370, feet 372, and nubs 374 as compared to those of the linear or straight cut blade 50.

Each of the julienne blades 364 and 366 also has a carrier 377. The julienne blade carriers 377 are identical to one another, but different from the carriers 368 of the straight cut and waffle blades. In this example, each carrier 377 has an identical midsection 378 that is also V-shaped and extending widthwise across the blade. Each of the julienne blades 364 and 366 also has a pair of supports or feet 380, one on each end of the respective midsection 378. In this example, each foot 380 has a second length, shorter than the first length of the feet 372 on the straight cut and waffle blades 50, 362. Each of the feet 380 also includes a nub 382 protruding rearward therefrom. The first julienne blade 364 has a plurality of cutting blades 384 that are widthwise spaced apart and upstanding from the midsection 378 of the carrier 377. The second julienne blade 366 has a plurality of similar upstanding cutting blades 386. The only difference is that the second julienne blade 366 has more blades 386 that are more closely spaced than the fewer blades 384 on the first julienne blade 364.

The frame 36 of the mandolin slicer 32 has a primary pocket pair 390, with one pocket formed in each of the frame sides 360. Each of the pockets 390 has a stepped configuration in this example. A first receptacle is formed at a higher elevation by a pair of lengthwise spaced apart steps 392. The steps 392 are spaced apart from one another to accommodate and support the length of the feet 372 on the straight blade 50 and waffle blade 362. Each of these blades requires that the cutting edge 54 or 376 be placed at about the same elevation as the surface of the upper tray 38. Each of the pockets 390 also has a second receptacle defined by a notch surface 394 positioned between the steps 392, but at a lower elevation, recessed further down into the sides 360 on the frame 36. The length of the notch surfaces 394 is sized to accommodate and support the shorter length of the feet 380 on the julienne blades 364, 366. The lower elevation of the notch surfaces 394 are such that the upstanding julienne blades 384 or 386 will be at the proper elevation during use.

A receiver or hole 396 is formed in a vertical wall facing the rear most step 392 and a receiver 398 is formed in a rear most wall facing the notched surface 394. Each of these receivers 396, 398 is configured to accept a nub 374 or 382, respectively, on a corresponding one of the blades when installed. With reference to FIG. 22A, the blade 50 can be inserted in the primary pocket 390 by orienting the blade at an angle with the nubs pointing rearward and down toward the pockets 390. The nubs 374 are inserted into the receivers 396 as shown in FIG. 22B. The carrier 368 is then dropped and rotated into position in the direction of the arrows in FIG. 22B until the feet 372 rest on the steps 392 as shown in FIG. 22C. If desired, one of the julienne blades 364, 366 can be optionally inserted into the primary pocket 390 prior to installation of the blade 50. To do so, the selected julienne blade 364 can be oriented at an angle with the nubs 382 pointing rearward and down as in FIG. 22A. The nubs 382 can be can be inserted into the receivers 398 as in FIG. 22B. The carrier 377 can then be dropped and rotated into position according to the arrows in FIG. 22B until the feet 380 contact the notch surfaces 394 as shown in FIG. 22C. The vertically oriented blades 384 will protrude upward. The blade 50 can then be installed as prescribed above directly over the julienne blade 364. The cutting-edge 54 is positioned such that it will lie adjacent the blades 384.

With reference to FIG. 23, the steps 392 of the pockets 390 define a pocket length L1 corresponding to the length of the feet 372 on the blades 50, 362. The notch surfaces 394 of the pockets 390 define a length L2 corresponding to the length of the feet 380 on the blades 364, 366. The frame 36 also has a plurality of storage pocket pairs 400, 402, and 404. The storage pockets in this example are positioned forward of the primary pocket 390 on the frame 36. The pair of pockets 400 in this example is configured to accommodate the waffle blade 362. Thus, a length L1 of the pockets 400 is essentially identical to that defined by the steps 392. The pockets 400 have receivers 406 in the rear most walls facing the pockets to receive the nubs 374 on the feet 372 of the blade 362. During use, the blade 50 can optionally be stored in the pocket pair 400 and of the waffle blade 362 can optionally be installed in the primary pockets 390 for use.

Each of the pair of pockets 402 and 404 in this example is configured to accommodate one of the julienne blades 364 and 366. Thus, the length L2 of these pockets is essentially identical to that defined by the notch surfaces 394 described above with respect to the primary pocket pair 390. The pockets 402, 404 each have receivers 408, 410, respectively for receiving the nubs 382 of the blades therein. When not being used, each of the julienne blades 364, 366 can be inserted and stored in one of the pocket pairs 402 or 404 in the manner described above for storage beneath the upper tray 38.

Different aspects of the disclosed mandolin slicer 32 can vary within the spirit and scope of the present invention. By way of example only, the number and type of replacement blades or optional slicing and julienne blades can vary from the specific arrangement disclosed and described herein. The julienne blade 364 is illustrated as being installed in position adjacent the cutting 52 of the blade 50 in FIGS. 16B, 17B, and 18B. Such a blade 364 can be selectively and optionally used to produce food items that are sliced horizontally but also diced vertically on each pass by the blades 364 and 50. These same FIGS. 16B, 17B, and 18B also illustrate the spare julienne blade 366 stored under the upper tray 38. The upper tray 38 can be lifted as described above to access spare blades or other optional blades and to swap out blades as desired. As noted above, other optionally selectable spare or replacement blades can also be stored within the mandolin slicer 32 beneath the upper tray 38, if desired.

As will be evident to those having ordinary skill in the art upon reading this disclosure, the specific components and arrangement of same as disclosed herein can vary within the spirit and scope of the present invention. Details of the safety mechanism 72 including the various components, slots, openings, pins, links, and the like can vary from the specific example shown and described herein and yet function as intended according to the teachings of the invention. Likewise, details of the height adjust mechanism 240 including the hoist, contoured slot, and rack and pinion gear can also vary from the specific example shown and described.

In only one of many possible examples, the safety mechanism can be configured so that the handle or actuator always returns to the released position from the actuated position when the user lets go of the handle. This can be so, even when the selection knob is in the locked position. Some other component of the safety mechanism can be configured to lock the blade guard in the blocking position, even if the handle returns to its released position. Likewise, this can also be so when the selection knob is in the guard OFF position. Again, some other component of the safety mechanism can be configured to hold the blade guard in the slicing position, even if the handle returns to its released position.

Although certain food slicer features, characteristics, and components have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A food slicer comprising:
a deck defining a food prep surface;
a blade oriented laterally across the deck and having a cutting edge exposed on the food prep surface; and
a safety mechanism with a blade guard positioned adjacent the cutting edge and movable between a blocking position blocking the cutting edge and a slicing position exposing the cutting edge,
wherein the safety mechanism can be user configured to allow selective movement of the blade guard between the blocking position and the slicing position.

2. A food slicer according to claim 1, wherein the safety mechanism has an actuator that is user actuable to move the blade guard from the blocking position to the slicing position, and wherein releasing the actuator can allow the blade guard to return to the blocking position.

3. A food slicer according to claim 2, wherein the actuator is a handle adjacent the deck that, when depressed, can move the blade guard to the slicing position and, when released, permits the blade guard to return to the blocking position.

4. A food slicer according to claim 1, wherein the safety mechanism can be user configured to lock the blade guard in the blocking position and can be user configured to release the blade guard for selective movement from the blocking position to the slicing position.

5. A food slicer according to claim 1, wherein the blade divides the deck into a pre-slice deck and a post-slice deck, and wherein an elevation of the pre-slice deck is adjustable relative to the position of the cutting edge to adjust a slice thickness produced by the food slicer.

6. A food slicer according to claim 1, wherein the blade is generally V-shaped and wherein the blade guard has a guard wall that is likewise V-shaped.

7. A food slicer according to claim 1, wherein the blade guard is lowered below a level of the cutting edge in the slicing position.

8. A food slicer according to claim 1, wherein the safety mechanism includes a selection device movable among a plurality of different user selectable positions.

9. A food slicer according to claim 8, wherein the selection device is movable to a locked position whereby the safety mechanism is maintained in a locked mode preventing the blade guard from moving to the slicing position.

10. A food slicer according to claim 8, wherein the selection device is movable to a guard OFF position whereby the safety mechanism is maintained in a guard OFF mode preventing the blade guard from returning to the blocking position.

11. A food slicer according to claim 10, wherein the selection device can be moved to the guard OFF position only if the blade guard is in the slicing position.

12. A food slicer according to claim 8, wherein the selection device is a rotatable selection knob and the safety mechanism has a cam disc coupled to the selection knob for rotation therewith.

13. A food slicer according to claim 12, wherein the safety mechanism further includes an actuator and a drive rod connecting the blade guard to the actuator whereby selective actuation of the actuator moves the blade guard.

14. A food slicer according to claim 13, wherein the cam disc cooperates with the drive rod to lock the blade guard in the blocking position and to release the blade guard, depending on the position of the selection knob.

15. A food slicer according to claim 13, wherein, when the safety mechanism is in a locked mode, the actuator can not be actuated or the blade guard can not be moved from the blocking position.

16. A food slicer according to claim 13, wherein, when the safety mechanism is in an unlocked mode, actuating the actuator moves the blade guard to the slicing position and releasing the actuator returns the blade guard to the blocking position.

17. A food slicer according to claim 1, wherein the safety mechanism can be selectively user arranged to a locked mode preventing the blade guard from moving from the blocking position, to a guard ON mode releasing the blade guard for selective movement between the blocking position and the slicing position, and to a guard OFF mode locking the blade guard in the slicing position.

18. A food slicer according to claim 1, wherein the deck is provided on an upper tray and wherein the safety mechanism can be selectively arranged to a tray release mode, whereby the upper tray is released from and movable relative to a frame of the food slicer to a position providing access beneath the deck within the frame.

19. A food slicer comprising:
a deck defining a food prep surface; and
a blade oriented laterally across the deck and having a cutting edge exposed on the food prep surface, the blade dividing the deck into a pre-slice deck and a post-slice deck,
wherein an elevation of the pre-slice deck is user adjustable relative to the position of the cutting edge to selectively adjust a slice thickness produced by the food slicer.

20. A food slicer according to claim 19, further comprising:
a knob rotatable to a plurality of user selectable orientations each associated with a different elevation of the pre-slice deck and rotatable to a release orientation allowing removal of the pre-slice deck; and
a safety mechanism with a blade guard positioned adjacent the cutting edge and movable between a blocking position blocking the cutting edge and a slicing position exposing the cutting edge.
